(19) United States
(12) Patent Application Publication
(10) Pub. No.: US 2026/0094475 A1
(43) Pub. Date: Apr. 2, 2026

(54) REAL-TIME RECEPTION AND INTEGRATION FOR COMMUNICATION BETWEEN DISSIMILAR SYSTEMS

(71) Applicant: The Boeing Company, Arlington, VA (US)

(72) Inventors: James Arlet Shadle, JR., Gig Harbor, WA (US); Benjamin Palfi, Kent, WA (US); Kevin M. Caldwell, Camano Island, WA (US)

(21) Appl. No.: 19/204,051

(22) Filed: May 9, 2025

Related U.S. Application Data
(60) Provisional application No. 63/701,486, filed on Sep. 30, 2024.

(51) Int. Cl. G07C 5/00; G07C 5/08; G07C 5/12

(52) U.S. Cl. CPC G07C 5/008; G07C 5/0808; G07C 5/12

(57) ABSTRACT

Testing coordination systems and a method of testing an aircraft are presented. A testing coordination system comprises a sequence coordination system stored on at least one sequence coordination server and configured to provide real-time reception and integration of data to provide communication between disparate systems while presenting a real-time changeable display.

### CROSS-REFERENCE TO RELATED APPLICATION

This application claims the benefit of U.S. Provisional Patent Application Ser. No. 63/701,486, filed Sep. 30, 2024, and entitled “Real-Time Reception and Integration for Communication between Dissimilar Systems,” which is incorporated herein by reference in its entirety.

### BACKGROUND INFORMATION

### 1. Field

The present disclosure relates generally to real-time integration or communication between systems.

### 2. Background

For commercial flight testing, the executing document, known as the sequence, is created by the test director (TD) who prints a copy for each test crew member. The average page count of a sequence is between 15-30 pages. The sequence is constantly adjusted prior to and throughout the test event. During flights, all participants will have to listen for changes and test condition status updates and sometimes those verbal communications are missed.

Therefore, it would be desirable to have a method and apparatus that takes into account at least some of the issues discussed above, as well as other possible issues.

### SUMMARY

An embodiment of the present disclosure provides a testing coordination system. The testing coordination system comprises a data storage server configured to receive onboard data from data sources on an aircraft in real-time, and a sequence coordination system on at least one sequence coordination server. The sequence coordination system is configured to receive the onboard data from the data storage server, convert to a visualization of the onboard data, integrate the visualization with data from dissimilar systems, and present the visualization and data from dissimilar systems in a real-time display.

Another embodiment of the present disclosure provides a testing coordination system. The testing coordination system comprises a sequence coordination system stored on at least one sequence coordination server and is configured to provide real-time reception and integration of data to provide communication between disparate systems while presenting a real-time changeable display.

Yet another embodiment of the present disclosure provides a method of testing of an aircraft using reduced audio communications. Data is accessed in real-time from dissimilar systems including onboard data sources of an aircraft. The data and a sequence of conditions for testing the aircraft are integrated to a coordinated visual format. The data is presented in the coordinated visual format on a changeable display in real-time. The changeable display is continuously updated based on additionally received changes to the data or the sequence of conditions in real-time.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a testing environment in accordance with an illustrative embodiment;

FIG. 3 is an illustration of a software architecture for a testing coordination system in accordance with an illustrative embodiment;

FIGS. 4A and 4B is an illustration of a flowchart of a method of testing an aircraft in accordance with an illustrative embodiment;

FIG. 5 is an illustration of a hardware layout for a testing coordination system in accordance with an illustrative embodiment;

FIG. 6 is an illustration of a hardware layout for a testing coordination system in accordance with an illustrative embodiment;

FIG. 7 is an illustration of a hardware layout for a testing coordination system in accordance with an illustrative embodiment;

FIG. 8 is an illustration of an interface for a sequence coordination system in accordance with an illustrative embodiment;

FIGS. 9A and 9B is an illustration of a test director display and a test participant display for a sequence coordination system in accordance with an illustrative embodiment;

FIG. 10 is an illustration of a navigation panel in accordance with an illustrative embodiment;

FIG. 11 is an illustration of a navigation panel in accordance with an illustrative embodiment;

FIG. 12 is an illustration of a navigation panel in accordance with an illustrative embodiment;

FIG. 13 is an illustration of a data panel in accordance with an illustrative embodiment;

FIG. 14 is an illustration of sequence condition controls in accordance with an illustrative embodiment;

FIG. 15 is an illustration of sequence condition controls in accordance with an illustrative embodiment;

FIG. 16 is an illustration of sequence following controls in accordance with an illustrative embodiment;

FIG. 17 is a flowchart of a method of testing of an aircraft using reduced audio communications in accordance with an illustrative embodiment;

FIG. 18 is an illustration of a block diagram of a data processing system in accordance with an illustrative embodiment;

FIG. 19 is an illustration of an aircraft manufacturing and service method in a form of a block diagram in accordance with an illustrative embodiment; and

FIG. 20 is an illustration of an aircraft in a form of a block diagram in which an illustrative embodiment may be implemented.

### DETAILED DESCRIPTION

The illustrative embodiments recognize and take into account that a “sequence” is a set of instructions and commands provided by a test director (TD) during a flight test. The illustrative embodiments recognize and take into account that the sequence is constantly adjusted prior to and throughout the test event. The illustrative embodiments recognize and take into account that paper sequences are outdated and are not aligned with the flight test digital thread: requirements—test planning—execution—reporting. The illustrative embodiments recognize and take into account that the paper sequence process does not allow for any type of data integration or alignment with MBSE.

The illustrative embodiments recognize and take into account that the current sequence is a non-interactive paper order of conditions which is printed for every test participant. The illustrative embodiments recognize and take into account that on a typical flight, the average number of printed copies can be 15. For a telemetry test event, the average number of copies can be 50. Re-printing copies after making adjustments is common.

The illustrative embodiments recognize and take into account that during the test event, all communications are verbal from the test director. The illustrative embodiments recognize and take into account that as the test director completes each step and/or makes changes to the condition order, all test participants are required to listen and mark their sequence accordingly. The illustrative embodiments recognize and take into account that if the verbal communication is missed, the test participants would have to call the test director to repeat the message.

The illustrative embodiments recognize and take into account that the current approach is to continue to print paper sequences. The illustrative embodiments recognize and take into account that the draw backs to the current approach include lack of interaction with the entire crew, reliance on a single source of communication (audio), relying on hearing the test director call outs, requiring to print using large amounts of paper, inefficient ability to update the sequence after printing, no tool integration, and no data integration.

The illustrative embodiments recognize and take into account that in the current methods, during development, desired conditions and condition blocks are organized and selected within planning software and a word document is extracted. The planning software may be referred to as the test planning execution and reporting tool (TPERT). The illustrative embodiments recognize and take into account that the test planning execution and reporting tool (TPERT) does not format a Word document in an executable and usable format. To format the Word document for use, font size is adjusted, page locations and/or page breaks are adjusted, and notes are added. Copies are printed for all participants.

The illustrative embodiments recognize and take into account that after development, the testing is executed. The illustrative embodiments recognize and take into account that during execution there is a preflight briefing, a walk through of the sequence, redlines (aka corrections) are added if desired, personal notes are added during the brief and conditions can be re-ordered.

The illustrative embodiments recognize and take into account that during execution a test director verbally alerts the crew to where the test is. The test director notes condition status. Conditions can be re-ordered if desired. Manual updates of condition status can be performed.

The illustrative embodiments recognize and take into account that after execution is post brief. In post brief a walk through is performed in the order printed. The illustrative embodiments recognize and take into account that in reporting after the execution, the printouts are reviewed to ensure all markings were captured. The illustrative embodiments recognize and take into account that the printouts are scanned as a PDF for data reporting (“Plans, Logs, and Data” (PL&D) reporting). The illustrative embodiments recognize and take into account that the PDF document presents conditions in the order printed. The illustrative embodiments recognize and take into account that the file is an image and is not searchable. The illustrative embodiments recognize and take into account that, currently, the planning software is used again after execution for condition status reporting.

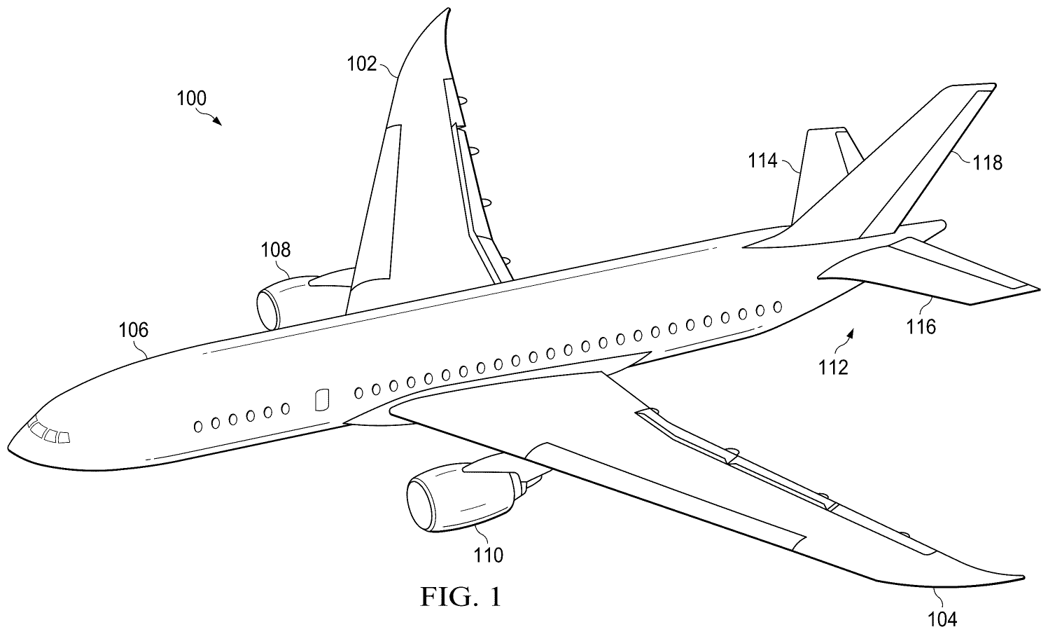

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have systems that are not configured for communication during flight. Aircraft 100 is an example of an aircraft that can be tested using a testing coordination system of the illustrative examples. The illustrative examples can provide real time reception and integration of communication between dissimilar systems of aircraft 100 and other systems. Aircraft 100 is an example of an aircraft that can be tested using a sequence coordination system of the illustrative examples.

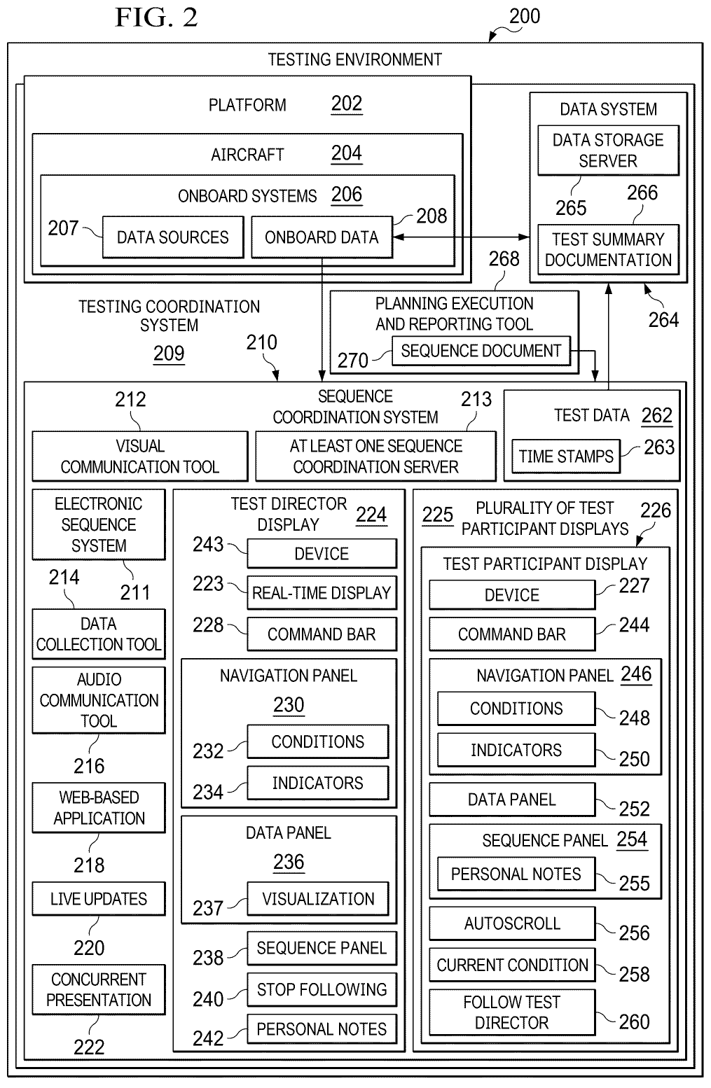

Turning now to FIG. 2, an illustration of a block diagram of a manufacturing environment is depicted in accordance with an illustrative embodiment. Testing coordination system 209 can be used to improve testing of aircraft 100 of FIG. 1.

Testing coordination system 209 enables communication and integration between onboard systems 206 and disparate systems of test director display 224 and plurality of test participant displays 225. In some illustrative examples, testing coordination system 209 comprises data storage server 265 configured to receive onboard data 208 from data sources 207 on aircraft 204 in real-time, and sequence coordination system 210 on at least one sequence coordination server 213. In some illustrative examples, the at least one sequence coordination sever 213 comprises a chat API, an E-sequence API, and a data API. Sequence coordination system 210 is configured to receive the onboard data 208 from data storage server 265, convert to visualization 237 of onboard data 208, integrate visualization 237 with 237 data from dissimilar systems, and present visualization and data from dissimilar systems in real-time display 223. In some illustrative examples, the data from dissimilar systems can comprise at least one of sequence document 270 from planning execution and reporting tool 268, input from plurality of test participant displays 225, or additional data from data system 264.

In some illustrative examples, data storage server 265 is onboard aircraft 204. In some illustrative examples, data storage server 265 takes the form of one of an ADAMS server. The ADAMS server can process sensor data into engineering units and sends it to ADSS. The ADSS server can be a publish/subscribe based data streaming server via a proprietary protocol.

In some illustrative examples, sequence coordination system 210 can be referred to as electronic sequence system 211 or E-SEQ. Sequence coordination system 210 acts as visual communication tool 212. Sequence coordination system 210 provides communication to a test director and test participants of onboard data 208. In some illustrative examples, sequence coordination system 210 can provide communication by creating chat rooms. Sequence coordination system 210 provides communication by allowing a test participant to select from autoscroll 256 and follow test director 260 to display information related to current condition 258. Sequence coordination system 210 can reduce audio communications during testing by providing additional data for visual communication. Sequence coordination system 210 also acts as a data collection tool 214. Sequence coordination system 210 provides for updating, reordering, and changing conditions 232 for testing. Sequence coordination system 210 can also add time stamps 263 to test data 262. In some illustrative examples, test data 262 can be logged by input provided by at least one of a test director on test director display 224 or a test participant on one of plurality of test participant displays 225. In some illustrative examples, sequence coordination system 210 integrates data received by users and onboard data 208.

In some illustrative examples, sequence coordination system 210 comprises audio communication tool 216. In some illustrative examples, audio communication tool 216 allows for a test director to provide audio instructions using device 243 presenting test director display 224. In some illustrative examples, audio communication tool 216 allows for test participants to receive audio instructions using devices presenting plurality of test participant displays 225, for example, device 227 presenting test participant display 226.

Sequence coordination system 210 provides for concurrent presentation 222 of updates to conditions 248 to test director display 224 and plurality of test participant displays 225. Concurrent presentation 222 of updates and data is performed in real-time.

In this illustrative example, real-time display 223 comprises test director display 224 comprising navigation panel 230, sequence panel 238, and data panel 236. As depicted, test director display 224 further comprises command bar 228. Command bar 228 includes buttons for control of the test in the graphical user interface. In some illustrative examples, command bar 228 includes at least one of a user login, locking changes, Data System Connection Modes, Data System Connection Status, and light/dark modes. Test director display 224 is configured to display the data from the dissimilar systems related to conditions 232 for the testing of aircraft 204.

Sequence coordination system 210 comprises test participant display 226 configured to automatically update current data related to conditions 248 with live updates 220. In some illustrative examples, the current data related to conditions 248 comprises indicators 250 to show a status of each of conditions 248. Indicators 234 of test director display show the same status of each of conditions 248. Indicators 234 and indicators 250 are updated in real-time.

In this illustrative example, test participant display 226 comprises command bar 244, navigation panel 246, sequence panel 254, and data panel 252. In some illustrative examples, test participant display 226 comprises an option to automatically present a view of test director display 224 in sequence panel 254 of test participant display 226. In some illustrative examples, command bar 244 comprises the same or similar buttons to command bar 228. Sequence panel 254 enables test participants to review the sequence and add personal notes 255 during development and testing. Personal notes 255 can be displayed only to the current participant for test participant display 226.

Sequence coordination system 210 is configured to automatically update the current status of conditions 248 in test participant display 226 by at least one of updating indicators 250 of conditions 248 in navigation panel 246 of test participant display 226 or displaying current condition 258 in sequence panel 254 of test participant display 226.

Sequence coordination system is a web-based application 218 configured to present onboard data 208 in a real-time display on a device independent of a type of operating system. Web-based application 218 allows sequence coordination system 210 to be run in a browser on device 227. Web-based application 218 allows sequence coordination system 210 to be run in a browser on device 243.

Sequence coordination system 210 is further configured to receive user input from real-time display 223 and associate a time stamp for user input with onboard data 208. In some illustrative examples, sequence coordination system 210 is configured to automatically integrate additional data received from at least one of real-time display 223, a plurality of test participant displays 225, or data storage server 265, and update each of real-time display 223 and plurality of test participant displays 225 in real-time.

In some illustrative examples, testing coordination system 209 comprises sequence coordination system 210 stored on at least one sequence coordination server 213 and is configured to provide real-time reception and integration of data to provide communication between disparate systems while presenting a real-time changeable display. In some illustrative examples, at least one sequence coordination server 213 provides real-time reception and integration of data from onboard sources including devices for test director display 224 and plurality of test participant displays 225. In some illustrative examples, at least one sequence coordination server 213 provides real-time reception and integration of data from offboard sources including devices for test director display 224 and plurality of test participant displays 225. In some illustrative examples, at least one sequence coordination server 213 provides real-time reception and integration of data from onboard and offboard sources including devices for test director display 224 and plurality of test participant displays 225. Each of test director display 224 and plurality of test participant displays 225 are real-time changeable displays. Sequence coordination system 210 is a web-based application 218 configured to present the real-time changeable display independently of a type of operating system.

Sequence coordination system 210 is configured to manage test director display 224 and plurality of test participant displays 225 in real-time to integrate and display updated data from test director display 224 and data sources 207 onboard aircraft 204 on each of plurality of test participant displays 225.

Sequence coordination system 210 is configured to manage test director display 224 and plurality of test participant displays 225 such that sequence coordination system 210 automatically presents a current view of sequence panel 238 of test director display 224 in respective sequence panels of plurality of test participant displays 225 in real-time.

Sequence coordination system 210 is configured to associate input received from at least one of test director display 224 or test participant display 226 of plurality of test participant displays 225 with data from the data sources onboard the aircraft in real-time.

Sequence coordination system 210 is configured to communicate a current status of testing using at least one of real-time updated icons, real-time updated colors, or real-time updated text. The current status can be communicated in at least one of the navigation panels or the sequence panels of respective real-time displays.

Although sequence coordination system 210 allows for real-time following of test director display 224, a test director can utilize stop following 240 and personal notes 242 to review conditions 232 without test participant confusion. In some illustrative examples, stop following 240 may be referred to as freeze following. A test director can utilize personal notes 242 to make notes that are not displayed to test participants.

Sequence coordination system 210 is a server-based application that provides an interactive digital sequence to the test participants. Sequence coordination system 210 uses REACT programming to present the sequence on any device with a web browser. As the test director makes changes to the sequence, updates are sent to all participants. Sending updates to all test participants provides visual communication as the test director steps through the sequence. The visual communication compliments the audio communication from the test director.

Sequence coordination system 210 allows for changes to be made to the sequence without printing. Changes to the sequences can be made prior and throughout the test event. The test director has the ability to control who is allowed to make changes, and sequence coordination system 210 logs a history of the changes. Sequence coordination system 210 also pairs the sequence with a data viewer. The data viewer allows the test director to manage the test event looking at critical parameters that affects the condition quality. This data viewer has the ability to set limits. The data viewer is shared with all test participants so that one participant's view can be shared with the other.

Sequence coordination system 210 provides value by reducing paper consumption, increasing test participants situational awareness (CRM), integrating with current data system and tools, and providing a fully customizable data viewer that improves upon and replaces current instrumentation hardware.

Sequence coordination system 210 enables advantages in reporting. Sequence coordination system 210 provides a clearer review to ensure all condition accounting was captured. Sequence coordination system 210 can produce test summary documentation 266. Sequence coordination system 210 can produce test summary documentation 266 that is an as-run sequence in PDF form. Test summary documentation 266 can be saved in the data system 264. Test summary documentation 266 can comprise at least one of onboard data 208, test data 262 including time stamps 263, personal notes 242, personal notes 255, conditions 232, test director notes, or any other desirable data related to performing conditions 232.

The illustration of testing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

Aircraft 204 is an example of a type of platform 202. Platform 202 can take a number of different forms. For example, platform 202 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a tanker aircraft, a surface ship, a tank, a personnel carrier, a train, a spacecraft, a space station, a satellite, a submarine, an automobile, a power plant, a bridge, a dam, a house, a manufacturing facility, a building, a robot, a robotic arm, a crane, and other suitable types of platforms.

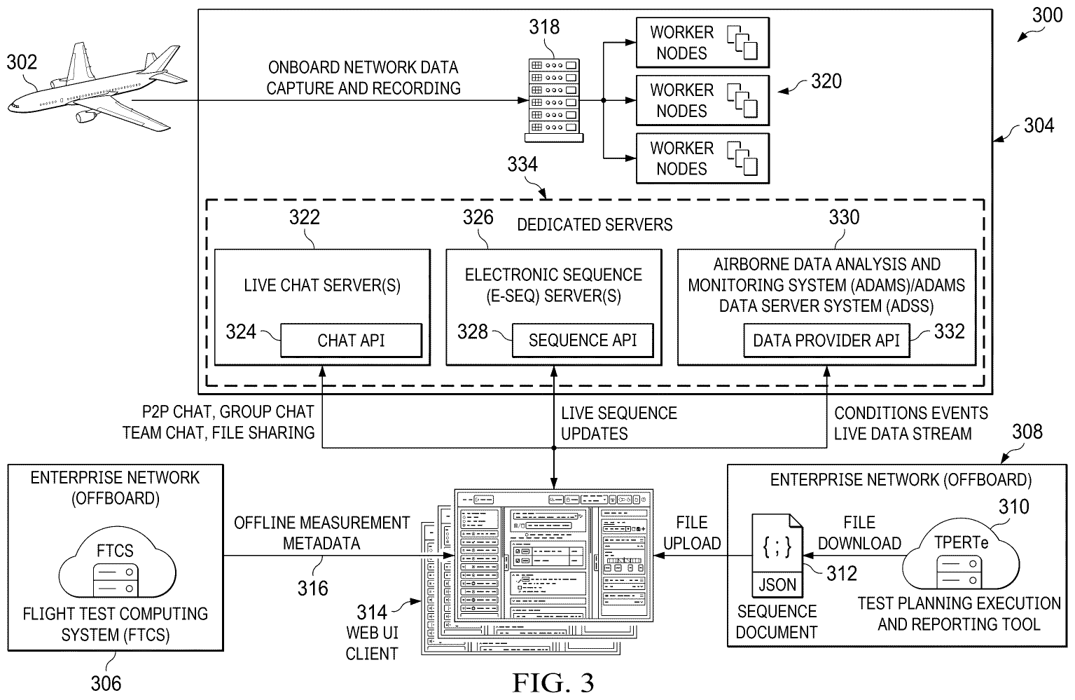

Turning now to FIG. 3, an illustration of a software architecture for a testing coordination system is depicted in accordance with an illustrative embodiment. Testing coordination system 300 can be a depiction of software architecture for testing coordination system 209 of FIG. 2. Testing coordination system 300 comprises existing systems 302 onboard an aircraft. Existing systems 302 can include data sources and sensors. Existing systems 302 can also include servers. Existing systems 302 can perform network data capture and recording.

Sequence coordination system 304 enables testing of an aircraft with reduced audio communications. Sequence coordination system 304 integrates into the current data system as much as possible. Sequence coordination system 304 integrates with existing systems 302.

Sequence coordination system 304 is able to write to the data system in existing systems 302 to assist with condition time recording. When a test director starts, pauses, and recurs a condition in sequence coordination system 304, the times are written to the data system in existing systems 302. In some illustrative examples, recurring conditions automatically adds the .X to the end of the condition number. In some illustrative examples, these times are written to a backup file which will be uploaded into a data archive.

In some illustrative examples, sequence coordination system 304 comprises dedicated servers 334. As depicted, sequence coordination system 304 comprises live chat servers 322, electronic sequence servers, and airborne data analysis and monitoring system 330. Chat application programming interface (API) 324 is present on live chat servers 322. In some illustrative examples, chat application programming interface (API) 324 can enable at least one of peer-to-peer (P2P) chat, group chat, team chat, or file sharing. Sequence coordination system 304 is a web-based application configured to present the onboard data in a real-time display on a device independent of a type of operating system. In some illustrative examples, sequence coordination system 304 uses REACT programming to present the sequence on any device with a web browser.

Sequence application programming interface (API) 328 is present on electronic sequence (E-SEQ) servers 326. Sequence application programming interface (API) 328 can enable real-time live updates to a sequence.

As depicted, data provider API 332 is present on airborne data analysis and monitoring system 330. Airborne data analysis and monitoring system 330 may also be referred to as airborne data analysis and monitoring system (ADAMS)/ADAMS Data Server System (ADSS). Data provider API 332 enables retrieval, storage, and presentation of data. Data provider API 332 enables retrieval, storage, and presentation of at least one of conditions, events, or live data stream.

In one illustrative example, sequence coordination system 304 comprises dedicated servers 334. In other illustrative examples, sequence coordination system 304 comprises Kubernetes cluster 318 and worker nodes 320.

Sequence coordination system 304 further comprises plurality of web user interface clients 314. Plurality of web user interface clients 314 creates graphical user interfaces for the test director and the test participants. Plurality of web user interface clients 314 creates a test director display and a plurality of test participant displays.

In this illustrative example, sequence coordination system 304 is on at least one sequence coordination server and is configured to receive onboard data from a data storage server, convert to a visualization of the onboard data, integrate the visualization with data from dissimilar systems, and present the visualization and data from dissimilar systems in a real-time display. In some illustrative examples, sequence coordination system 304 is further configured to receive user input from the real-time display and associate a time stamp for the user input with the onboard data. The user input can be received through plurality of web user interface clients 314.

Sequence coordination system 304 is depicted as communicating with onboard systems and offboard systems. In some illustrative examples, the offboard systems comprise enterprise network 308. In some illustrative examples, aircraft 302 is not connected to the internet during testing. In these illustrative examples, aircraft 302 is not connected to enterprise network 308 when in flight and testing. In some illustrative examples, sequence coordination system 304 operates with onboard systems separately from offboard systems. In some illustrative examples, an instance of sequence coordination system 304 operates in conjunction with enterprise network 308 in preflight and postflight. In some illustrative examples, an instance of sequence coordination system 304 operates onboard aircraft 302 in during testing in-flight.

In this illustrative example, sequence coordination system 304 interfaces with offboard systems. In some illustrative examples, sequence coordination system 304 is configured to receive data from both onboard and offboard systems and integrates the data from these dissimilar systems. Depicted offboard systems comprise Flight Test Computing System 306 and Test Planning Executing and Reporting Tool 310. Sequence coordination system 304 receives offline measurement metadata 316 from flight test computing system 306. Sequence coordination system 304 receives sequence document 312 from test planning execution and reporting tool 310. Sequence document 312 can take the form of a JSON document or a Word document.

Sequence coordination system 304 is configured to automatically integrate additional data received from at least one of the real-time display, a plurality of test participant displays, or the data storage server and update each of the real-time display and the plurality of test participant displays in real-time. The additional data can be received from existing systems 302 or one of plurality of web user interface clients 314 and integrated by sequence coordination system 304 to update displays created by plurality of web user interface clients 314 in real-time.

Sequence coordination system 304 enables testing of an aircraft using reduced audio communications. The reduced audio communications can be achieved through the integration of real-time data from dissimilar systems. The reduced audio communications can be achieved by navigable conditions and condition blocks. The reduced audio communications can be achieved by providing notes from at least one of the test director or the test participants. The reduced audio communications can be achieved by highlighting or other indications of current conditions. The reduced audio communications can be achieved by tracking the test director's movement through the conditions. The reduced audio communications can be achieved by automatically updating a status of a condition in real-time.

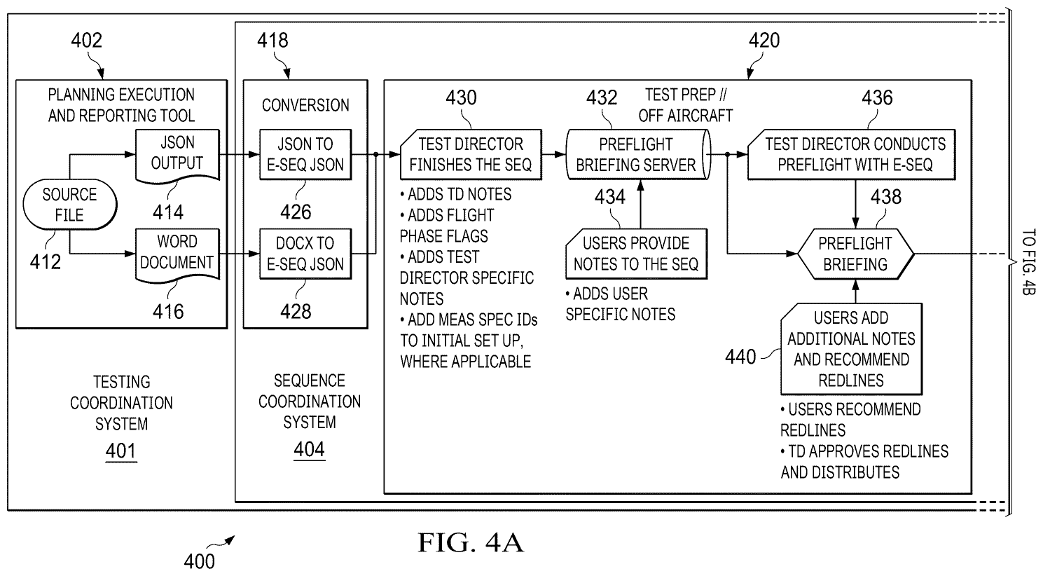

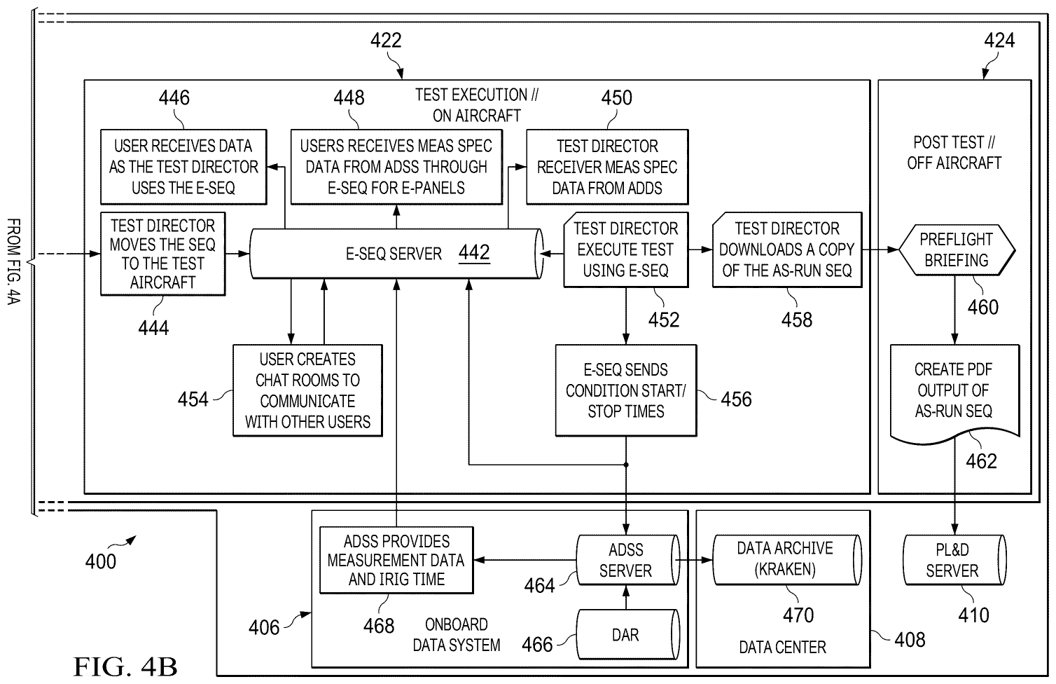

Turning now to FIGS. 4A and 4B, an illustration of a flowchart of a method of testing an aircraft is depicted in accordance with an illustrative embodiment. Method 400 can be performed to test a component of aircraft 100 of FIG. 1. Method 400 can be performed using testing coordination system 209 of FIG. 2. Method 400 can be performed using components of testing coordination system 300 of FIG. 3.

Planning Execution and Reporting Tool 402 may be referred to as a condition organization system in this illustrative example. Planning Execution and Reporting Tool 402 is used to organize desired conditions for testing into a source file 412. Source file 412 is used to generate at least one of JSON Output 414 or Word document 416. One of JSON output 414 or Word document 416 is provided to sequence coordination system 404. Sequence coordination system 404 performs conversion 418. In some illustrative examples, conversion 418 converts JSON output 414 to E-SEQ JSON 426. In some illustrative examples, conversion 418 converts word document (DocX) 416 to E-SEQ JSON 428.

The illustrative examples enable a testing method that is at least one of less wasteful, less time consuming, or easier than prior methods of performing testing. Using the testing coordination system in development, the test director can organize within the planning software. At least one of a JSON file or a Word document is downloaded. The at least one of a JSON file or a word document is loaded into the sequence coordination system. During development, notes can be added directly into the sequence coordination system. The notes can include at least one of test director notes to be shared with all users or personal notes that will be saved but not shared during testing.

For example, during test preparation 420 off-aircraft, the test director can finish the sequence in operation 430 in the sequence coordination system. Finishing the sequence can comprise at least one of adding test director notes, adding flight phase flags, adding test director specific notes not to be shared with test participants, or adding measurement spec IDs to the initial set-up. The measurement spec IDs identify the data parameter to be viewed (e.g., airspeed, altitude, flap position). Parameter names in the initial setup can be identified by measurement number for viewing on the eSeq. In some illustrative examples, finishing the sequence can comprise pre-populating the list of measurements that will be utilized for a condition in the data viewer pane. Finishing the sequence can comprise populating the initial setup tables in the conditions to tie test setup requirements to measurement data. Test preparation 420 can also be referred to as development.

Changes made by the test director in operation 430, are provided to preflight briefing server 432. In some illustrative examples, preflight briefing server 432 is a separate server from onboard servers. In some illustrative examples, preflight briefing server 432 is a clone of an onboard server. In some illustrative examples, preflight briefing server 432 is run on an enterprise network. In some illustrative examples, the airplane or “onboard” server is a separate server, which can run the same software. In some illustrative examples, the airplane network is air gapped. In some illustrative examples, relevant data from preflight briefing server 432 is copied to the onboard server via physical storage to synchronize what was done in preflight to the airplane. Test participants, which may be referred to as users, can provide notes to the sequence in operation 434. The user notes can be user specific notes that will not be displayed to others. Notes provided by test participants are provided to preflight briefing server 432.

Preflight briefing 438 can be conducted using sequence coordination system 404. The test director conducts preflight briefing with sequence coordination system (E-Seq) 404 in operation 436. During preflight briefing 438, users can add additional notes and recommend redlines in operation 440. In operation 440, test participants can recommend redlines. The test director can approve redlines and distribute. Sequence coordination system 404 can distribute redlines or changes to the sequence in real-time.

The sequence coordination system enables real-time reception and integration of updates, changes, or data for the conditions without font changes, page adjustments, or printing. The sequence coordination system enables the test participants to review the sequence and add personal notes during development.

The testing coordination system enables preview of a sequence, a preflight briefing, adding redlines for all participants in real-time, and updating condition re-ordering in real-time.

During test execution, the test director can update the participants in real-time. In some illustrative examples, the test director can update the participants at least one of verbally or visually in the sequence coordination system. During the execution, the test director updates condition status in real time. The sequence coordination system enables re-ordering conditions in real-time. The sequence coordination system has onboard tools integration that integrates communication between dissimilar systems on the aircraft with other off-board systems.

Test Execution 422 is improved by use of sequence coordination system 404. Portions of test execution 422 are performed on the aircraft while some participants in the test can be off board. In some illustrative examples, E-sequence (E-SEQ) server 442 receives onboard data as well as onboard inputs from users. In some illustrative examples, E-sequence (E-SEQ) server 442 receives onboard and offboard data as well as onboard and offboard inputs. E-sequence (E-SEQ) server 442 receives data from several sources, creates visualizations using the data, and integrates the visualizations with data from onboard data system 406. E-sequence (E-SEQ) server 442 can be one or more servers for implementing sequence coordination system 404. E-sequence (E-SEQ) server 442 of FIG. 4 represents a combination of live chat servers 322, electronic sequence (E-SEQ) servers 326, and airborne data analysis and monitoring system 330 of FIG. 3. Electronic sequence (E-SEQ) servers 326 of FIG. 3 handles the sequence document communication, updates, and storage of the sequence. ADAMS/ADSS Data provider API server 332 of FIG. 3 handles the live data streaming. Live chat servers 322 handle the chat data streaming. In some illustrative examples, live chat servers 322 electronic sequence (E-SEQ) servers 326 are combined, while data analysis and monitoring system 330 is a separate server in the e-seq “application stack”.

The test director moves the sequence to the test aircraft in operation 444. A user creates chat rooms to communicate with other users in operation 454. Operation 454 can be optional. Operation 454 can reduce audio communication during the testing. Operation 454 can also improve the accuracy and efficiency of the testing through enhanced communication. In operation 446, users, such as test participants, receive data as the test director uses the sequence coordination system. The data can include test director notes, identification of the current condition, indications of a status of a condition, redlines, or other data during the test. Operation 446 is repeatedly performed during test execution 422 to update a test participant display in real-time.

In operation 448, users receive Mass Spec data from ADSS through E-SEQ for the panels in a test participant display. Adams Data Server System (ADSS) Server 464 and data acquisition and recording (DAR) 466 are present in onboard data system 406. Sequence coordination system 404 communicates with onboard data system 406 to receive data from onboard data sources and onboard sensors. In operation 468, ADSS provides measurement data and inter-range instrumentation group (IRIG) time in real-time to E-sequence (E-SEQ) server 442.

In operation 450, the test director receives the mass spec data from ADSS. The data from onboard data system 406 is received and integrated in real-time to update a test director display and a plurality of test participant displays.

In operation 452, the test director executes the testing using the sequence coordination system (E-SEQ). During the testing, the sequence coordination system (E-SEQ) sends Start/stop times to E-SEQ server 442 and ADSS Server 464. Condition start/stop times are integrated with onboard data. Data from ADSS Server 464 is also sent to data center 408 for storage in data archive 470. Integrating start/stop times using the sequence coordination system improves accuracy of the testing data stored in data archive 470. Time stamps generated during the testing by the sequence coordination system improve the accuracy of the data.

Following test execution 422, the test director downloads a copy of the as-run sequence in operation 458. The generation of the as-run sequence saves time and energy compiling notes, data, and condition changes. After test execution 422, post test 424 is performed. Postflight briefing 460 is performed off board. In postflight briefing 460, the sequence coordination system enables a walk through in the order flown.

Following post brief, the sequence coordination system enables advantages in reporting. The sequence coordination system provides a clearer review to ensure all condition accounting was captured. The sequence coordination system can produce an as-run sequence and convert to a PDF. In operation 462 a PDF output is created of the as-run sequence. The As-run sequence in PDF form can be saved in the Plans, Logs, & Data (PL&D) server in operation 410.

Sequence coordination system 404 will show a list of conditions in the order flown. Sequence coordination system 404 enables showing conditions in a modified order including any changes in order from an initial order.

In some illustrative examples, an output of the sequence coordination system 404 is a searchable digital output. In some illustrative examples, the condition completion status can be updated in TPERT following testing. Benefits of the use of sequence coordination system 404 can be observed in development/test preparation 420, test execution 422, and post testing 424. In test preparation 420, sequence coordination system 404 eliminates time spent formatting for font changes, table alignments, and page adjustments. Sequence coordination system 404 eliminates printing. Sequence coordination system 404 enables test participants to review a copy of the final sequence prior to the preflight brief in operation 440. Sequence coordination system 404 enables adding personal notes prior to the Preflight Brief.

During test execution 422, sequence coordination system 404 provides real time updates for: Following, Test Director Notes, Redlines, and Re-Ordering Conditions. Sequence coordination system 404 enhances crew resource management by visually pairing condition status with verbal callouts. Sequence coordination system 404 increases communication while reducing an amount of verbal communication. Synchronized Step Completion, Real Time Following and Condition Status/Order Updates, and Onboard Tools Integration of sequence coordination system 404 provide more information to test participants and the test director than would be available without sequence coordination system 404.

In post testing 424, the postflight brief can be performed in the order flown. Sequence coordination system 404 enables participants access to copies of the as-run sequence. Users can download a copy of the As-Run Sequence. Sequence coordination system 404 eliminates scanning in the As-Run Sequence. Sequence coordination system 404 generates an as-run sequence that can be more easily integrated into the PL&D server. The as-run sequences are searchable.

Sequence coordination system 404 provides instrumentation enhancements. Sequence coordination system 404 eliminates panels hardware for Test Director. For example, the sequence coordination system 404 provides for display of test data without using a LADS system for the test director. In some illustrative examples, sequence coordination system 404 provides an inter-range instrumentation group (IRIG) timer for the Test Director.

Sequence coordination system 404 allows the Test Director to bring more information onboard by integrating both onboard data and offboard data into a single system that can be navigated.

Sequence coordination system 404 provides meta data output for consumption into a data processing center. In some illustrative examples, sequence coordination system 404 comprises chatrooms that provide the ability for test participants to communicate and send files to other participants, or groups of participants.

In some illustrative examples, sequence coordination system 404 provides PDF output capability for manual record keeping. The sequence coordination system provides an ability to ingest DOCX and JSON outputs. The sequence coordination system provides an ability to generate a JSON output of a completed sequence.

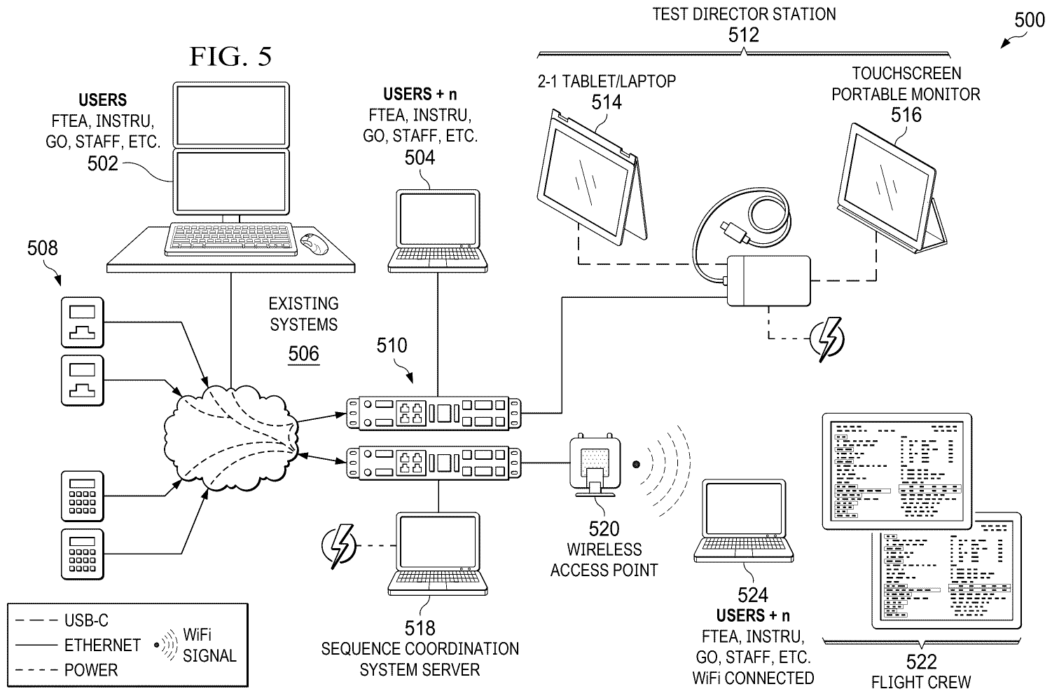

Turning now to FIG. 5, an illustration of a hardware layout for a testing coordination system is depicted in accordance with an illustrative embodiment. Testing coordination system 500 can be used to test a component of aircraft 100 of FIG. 1. Testing coordination system 500 can be a hardware set-up for testing coordination system 209 of FIG. 2. Testing coordination system 500 can be a hardware set-up to be used with testing coordination system 300 of FIG. 3. Method 400 can be performed using testing coordination system 500 of FIG. 5.

In some illustrative examples, testing coordination system 500 makes use of existing hardware as much as possible. In some illustrative examples, making use of existing hardware reduces at least one of cost or complexity of implementing testing coordination system 500.

In this illustrative example, onboard users 502 are connected to data sensors and sources 508. Onboard users 502 have limited locations and limited access. In some illustrative examples, onboard users 502 can have displays that are at least one of undesirably difficult to access, undesirably difficult to read, or can be unable to communicate onboard data.

In this illustrative example, onboard users 504 are connected to servers 510. In some illustrative examples, onboard users 504 can have limited access to servers 510 during operation of an aircraft. For example, some operating systems may not interface with some of servers 510. As depicted servers 510 comprise a test director server. However, in some illustrative examples, servers 510 may not include a test director server or other servers beneficial for testing. If a test director server is not available in servers 510, sequence coordination system server 518 can be utilized. In some illustrative examples, sequence coordination system server 518 is optional.

Testing coordination system 500 comprises existing systems 506. Existing systems 506 can comprise at least one of onboard or offboard systems. In this illustrative example, existing systems 506 comprise data sensors and sources 508. Existing systems 506 also comprise servers 510. In some illustrative examples, servers 510 comprise at least one of software servers or data servers.

Testing coordination system 500 provides integration and communication between dissimilar systems including dissimilar devices. In this illustrative example, test director station 512 of testing coordination system 500 comprises a plurality of devices. In this illustrative example, a sequence coordination system can be run on device 514 and displayed on device 516. In this illustrative example, device 514 takes the form of a 2-in-1 tablet/laptop. In this illustrative example, device 516 takes the form of a touchscreen portable monitor. In other illustrative examples, device 514 and device 516 can take any other desirable form.

In this illustrative example, sequence coordination system server 518 is connected to servers 510. Sequence coordination system server 518 provides access to onboard data from data sensors and sources 508 previously unavailable to users other than onboard users 502. Sequence coordination system server 518 integrates communication between dissimilar systems. Sequence coordination system server 518 allows accessing in real-time and provides input and display to the user in real-time. Sequence coordination system server 518 provides real-time reception and integration of input from existing systems 506 and provides real-time display and changeable display to test director station 512, flight crew devices 522, and devices of additional users 524.

In this illustrative example, flight crew devices 522 comprise tablets. In other illustrative examples, flight crew devices 522 can take the form of alternative devices to tablets. In this illustrative example, Wi-Fi has been added for flight crew devices 522. In this illustrative example, wireless access point 520 provides wireless access to flight crew devices 522. By providing wireless access point 520, flight crew devices 522 have access to the sequence coordination system while eliminating wires to flight crew devices 522. Wireless access point 520 can be used to connect users to the DAR network. The DAR network can contain all test data flowing on the test aircraft as well as all inter service communication. This includes connectivity to existing systems, and the sequence coordination server/td software server. Devices with appropriate core clients and desire operating systems can allow users to connect to ADAMS/ADSS, LADS, etc. using wireless access point 520. The sequence coordination system enables access to data provided by ADAMS/ADSS to all users independent of a type of operating system. The sequence coordination system enables access to data provided by ADAMS/ADSS to all users independent of a type of device.

In some illustrative examples, the additional users for devices of additional users 524 are onboard test participants. In some illustrative examples, the additional users for devices of additional users 524 include at least one of onboard test participants or offboard test participants. Onboard devices of devices of additional users 524 can also utilize wireless access point 520. In the case of telemetry, if satellite connections are utilized, offboard devices of devices of additional users 524 can utilize satellite data to access sequence coordination system server 518.

In this illustrative example, the sequence coordination system is a web-based application configured to be run on at least one of a tablet, laptop, computer, 2-in-1 tablet, or any other desirable device regardless of operating system.

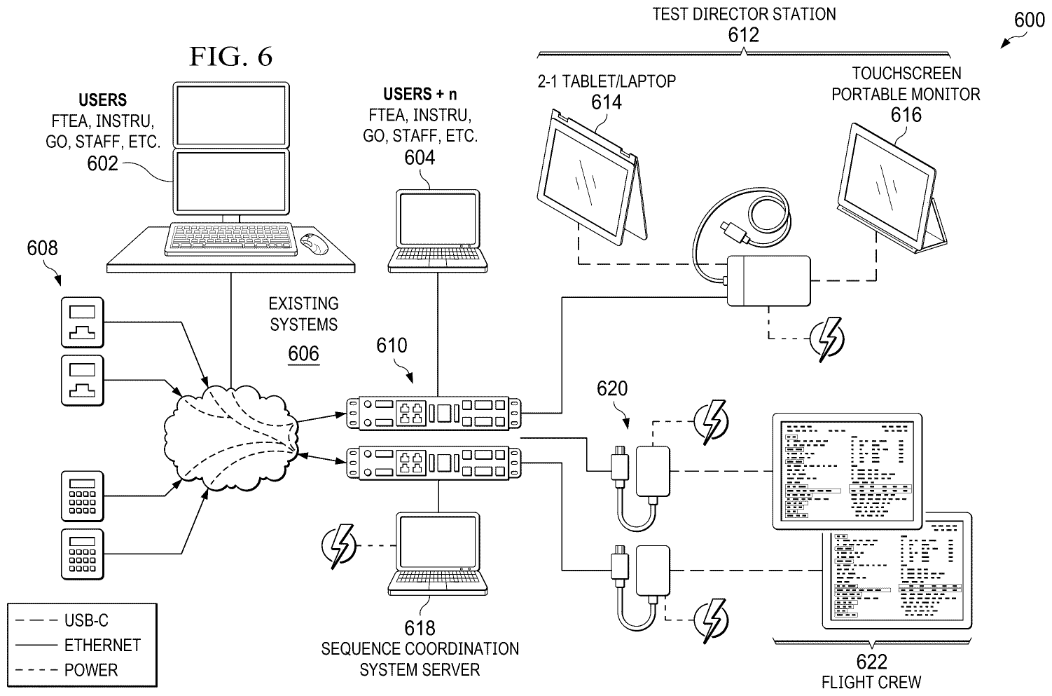

Turning now to FIG. 6, an illustration of a hardware layout for a testing coordination system is depicted in accordance with an illustrative embodiment. Testing coordination system 600 can be used to test a component of aircraft 100 of FIG. 1. Testing coordination system 600 can be a hardware set-up for testing coordination system 209 of FIG. 2. Testing coordination system 600 can be a hardware set-up to be used with testing coordination system 300 of FIG. 3. Method 400 can be performed using testing coordination system 600 of FIG. 6.

In some illustrative examples, testing coordination system 600 makes use of existing hardware as much as possible. In some illustrative examples, making use of existing hardware reduces at least one of cost or complexity of implementing testing coordination system 600.

In this illustrative example, onboard users 602 are connected to data sensors and sources 608. Onboard users 602 have limited locations and limited access. In some illustrative examples, onboard users 602 can have displays that are at least one of undesirably difficult to access, undesirably difficult to read, or can be unable to communicate onboard data.

In this illustrative example, onboard users 604 are connected to servers 610. In some illustrative examples, onboard users 604 can have limited access to servers 610 during operation of an aircraft. For example, some operating systems may not interface with some of servers 610. As depicted servers 610 comprise a test director server. However, in some illustrative examples, servers 610 may not include a test director server or other servers beneficial for testing. If a test director server is not available in servers 610, sequence coordination system server 618 can be utilized. In some illustrative examples, sequence coordination system server 618 is optional.

Testing coordination system 600 comprises existing systems 606. Existing systems 606 can comprise at least one of onboard or offboard systems. In this illustrative example, existing systems 606 comprise data sensors and sources 608. Existing systems 606 also comprise servers 610. In some illustrative examples, servers 610 comprise at least one of software servers or data servers.

Testing coordination system 600 provides integration and communication between dissimilar systems including dissimilar devices. In this illustrative example, test director station 612 of testing coordination system 600 comprises a plurality of devices. In this illustrative example, a sequence coordination system can be run on device 614 and displayed on device 616. In this illustrative example, device 614 takes the form of a 2-in-1 tablet/laptop. In this illustrative example, device 616 takes the form of a touchscreen portable monitor. In other illustrative examples, device 614 and device 616 can take any other desirable form.

In this illustrative example, sequence coordination system server 618 is connected to servers 610. Sequence coordination system server 618 provides access to onboard data from data sensors and sources 608 previously unavailable to users other than onboard users 602. Sequence coordination system server 618 integrates communication between dissimilar systems. Sequence coordination system server 618 allows accessing in real-time and provides input and display to the user in real-time. Sequence coordination system server 618 provides real-time reception and integration of input from existing systems 606 and provides real-time display and changeable display to test director station 612 and flight crew devices 622.

In this illustrative example, flight crew devices 622 are connected by wires to servers 610. In this illustrative example, flight crew devices 622 are connected by connection points 620. In this illustrative example, flight crew devices 622 are tablets.

Although not depicted here, additional onboard test participants or offboard test participants can utilize the sequence coordination system. In this illustrative example, the sequence coordination system is a web based application configured to be run on at least one of a tablet, laptop, computer, 2-in-1 tablet, or any other desirable device regardless of operating system.

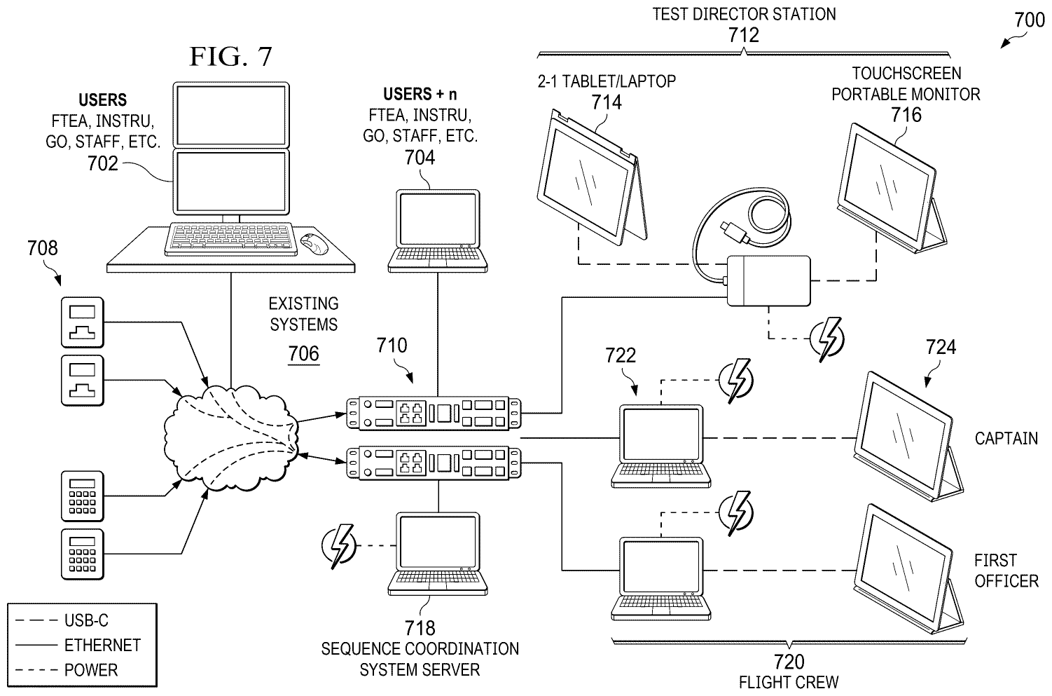

Turning now to FIG. 7, an illustration of a hardware layout for a testing coordination system is depicted in accordance with an illustrative embodiment. Testing coordination system 700 can be used to test a component of aircraft 100 of FIG. 1. Testing coordination system 700 can be a hardware set-up for testing coordination system 209 of FIG. 2. Testing coordination system 700 can be a hardware set-up to be used with testing coordination system 300 of FIG. 3. Method 400 of FIG. 4 can be performed using testing coordination system 700 of FIG. 7.

In some illustrative examples, testing coordination system 700 makes use of existing hardware as much as possible. In some illustrative examples, making use of existing hardware reduces at least one of cost or complexity of implementing testing coordination system 700.

In this illustrative example, onboard users 702 are connected to data sensors and sources 708. Onboard users 702 have limited locations and limited access. In some illustrative examples, onboard users 702 can have displays that are at least one of undesirably difficult to access, undesirably difficult to read, or can be unable to communicate onboard data.

In this illustrative example, onboard users 704 are connected to servers 710. In some illustrative examples, onboard users 704 can have limited access to servers 710 during operation of an aircraft. For example, some operating systems may not interface with some of servers 710. As depicted servers 710 comprise a test director server. However, in some illustrative examples, servers 710 may not include a test director server or other servers beneficial for testing. If a test director server is not available in servers 710, sequence coordination system server 718 can be utilized. In some illustrative examples, sequence coordination system server 718 is optional.

Testing coordination system 700 comprises existing systems 706. Existing systems 706 can comprise at least one of onboard or offboard systems. In this illustrative example, existing systems 706 comprise data sensors and sources 708. Existing systems 706 also comprise servers 710. In some illustrative examples, servers 710 comprise at least one of software servers or data servers.

Testing coordination system 700 provides integration and communication between dissimilar systems including dissimilar devices. In this illustrative example, test director station 712 of testing coordination system 700 comprises a plurality of devices. In this illustrative example, a sequence coordination system can be run on device 714 and displayed on device 716. In this illustrative example, device 714 takes the form of a 2-in-1 tablet/laptop. In this illustrative example, device 716 takes the form of a touchscreen portable monitor. In other illustrative examples, device 714 and device 716 can take any other desirable form.

In this illustrative example, sequence coordination system server 718 is connected to servers 710. Sequence coordination system server 718 provides access to onboard data from data sensors and sources 708 previously unavailable to users other than onboard users 702. Sequence coordination system server 718 integrates communication between dissimilar systems. Sequence coordination system server 718 allows accessing in real-time and provides input and display to the user in real-time. Sequence coordination system server 718 provides real-time reception and integration of input from existing systems 706 and provides real-time display and changeable display to test director station 712 and flight crew devices 720.

In this illustrative example, flight crew devices 720 are connected by wires to servers 710. In this illustrative example, flight crew devices 720 comprise laptops 722 and tablets 724.

Although not depicted here, additional onboard test participants or offboard test participants can utilize the sequence coordination system. In this illustrative example, the sequence coordination system is a web-based application configured to be run on at least one of a tablet, laptop, computer, 2-in-1 tablet, or any other desirable device regardless of operating system.

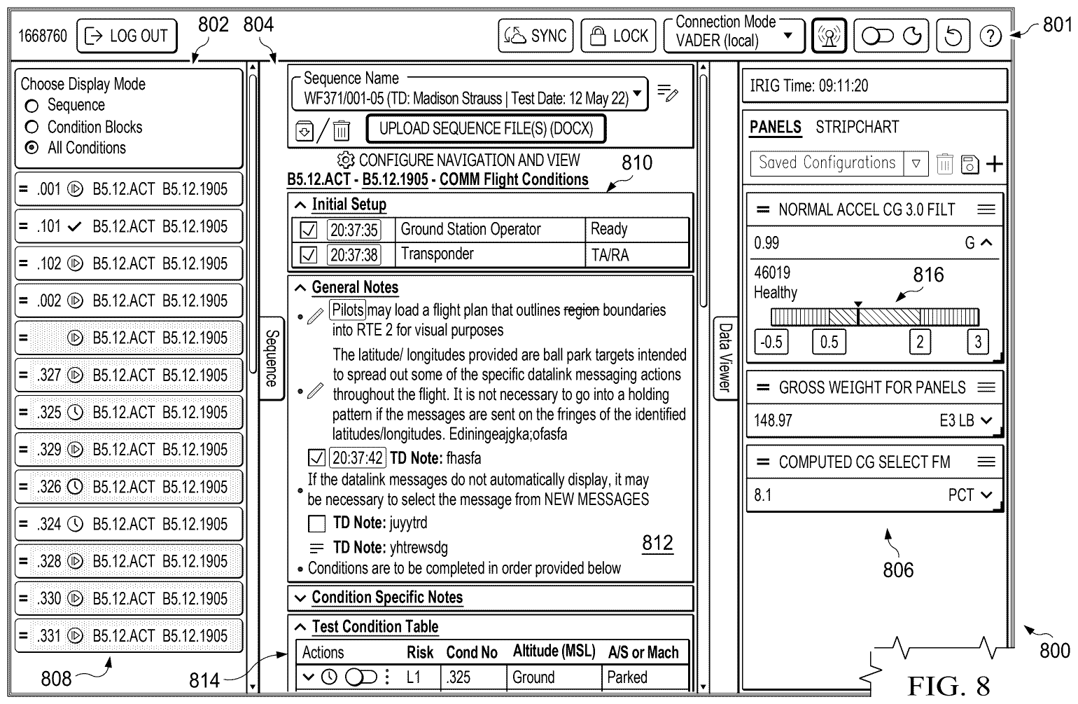

Turning now to FIG. 8, an illustration of an interface for a sequence coordination system is depicted in accordance with an illustrative embodiment. Interface 800 can take the form of one of a test director display or a test participant display. Interface 800 can be an implementation of one of test director display 224 or test participant display 226 of FIG. 2. Interface 800 can be generated by one of plurality of web UI clients 314 of FIG. 3. Interface 800 can be generated and used during one of test preparation 420 or test execution 422 of FIG. 4. Interface 800 can be displayed on at least one of test director station 512, flight crew devices 522, or user devices of additional users 524 of FIG. 5. Interface 800 can be displayed on at least one of test director station 612 or flight crew devices 622 of FIG. 6. Interface 800 can be displayed on at least one of test director station 712 or flight crew devices 720 of FIG. 7.

Command bar 801 includes several buttons for control of the test in the graphical user interface. As depicted, buttons on command bar 801 include a user login, locking changes, Data System Connection Modes, Data System Connection Status, and light/dark modes. In some illustrative examples, alert messages can appear in the browser. In some illustrative examples, the alert messages can appear in the lower left of the browsers. Alert messages can appear for either a short time or can persist. In some illustrative examples, some messages will appear for ˜5 seconds. In some illustrative examples, some messages will persist until closed. In some illustrative examples, persistent messages can be indicated with a notation, such as P. In some illustrative examples, an alert message can comprise one of warning, caution, advisory, completion, or status.

Interface 800 further comprises navigation panel 802, sequence panel 804, and data panel 806. In some illustrative examples, custom limits for onboard data viewing are provided using data panel 806.

Navigation panel 802 displays planning information for a sequence, condition blocks, or conditions. In this illustrative example, navigation panel 802 presents plurality of conditions 808.

Information for the conditions selected in navigation panel 802 is displayed in sequence panel 804. Sequence panel 804 can present at least one of FTP Information, initial setup 810, procedure steps, general notes 812, condition specific notes (ball notes), condition block, conditions 814, or post test condition block. Conditions 814 can be displayed in a test condition table. Sequence panel 804 can present at least one of user added information, test director notes, personal notes linked to BEMS, condition status, or redlines.

Data panel 806 displays data related to the conditions to be performed. The data presented in data panel 806 can be provided by onboard data sources or offboard data sources. The sequence coordination system integrates data from disparate systems. In this illustrative example, data is displayed as graphics bar 816 with color indicators.

Although navigation panel 802, sequence panel 804, and data panel 806 are displayed from left to right, an order of the panels can be changed. In some illustrative examples, the order of the panels can be changed with drag and drop.

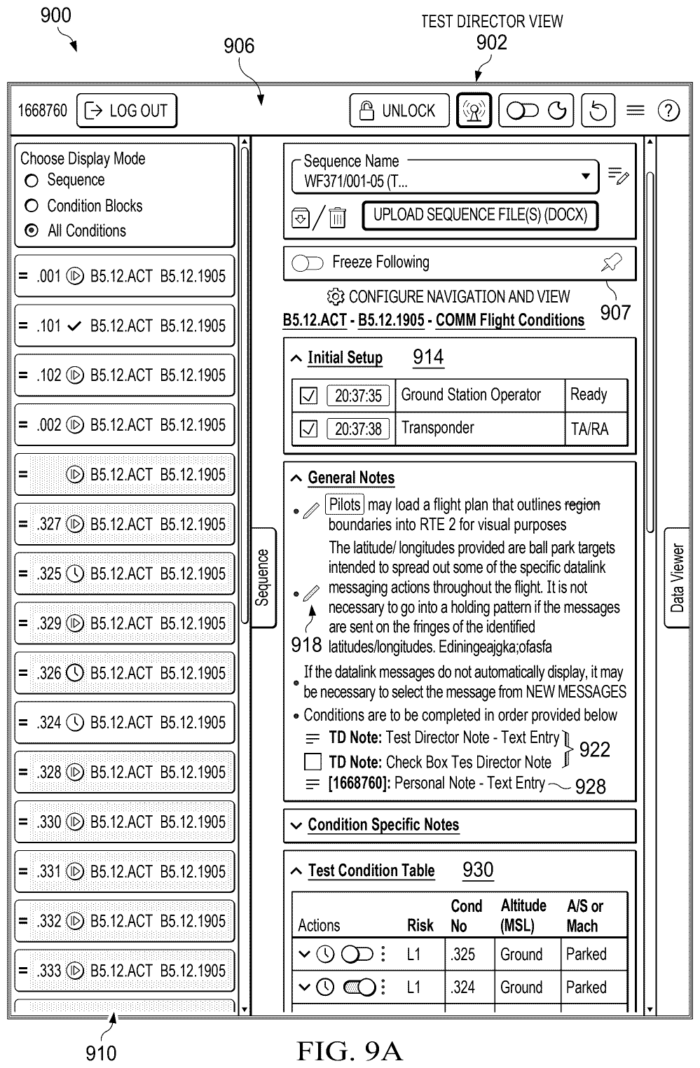

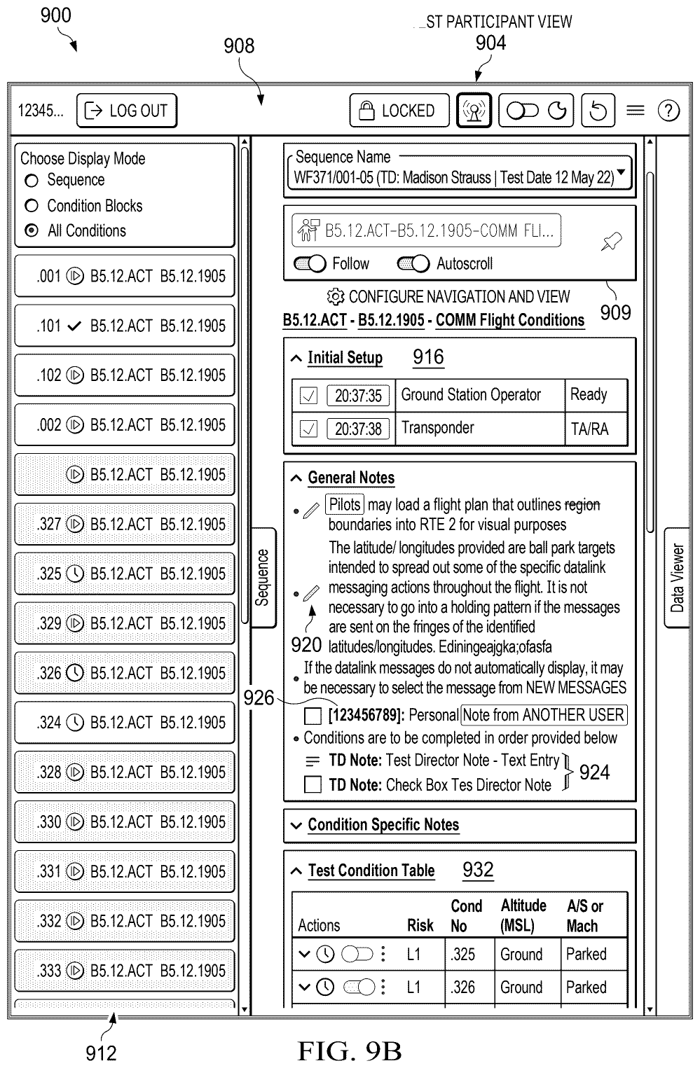

Turning now to FIGS. 9A and 9B, an illustration of a test director display and a test participant display for a sequence coordination system is depicted in accordance with an illustrative embodiment. View 900 depicts two different displays side by side to demonstrate aligned data between test director view 902 and test participant view 904. Test director view 902 will be presented on one or more devices for the test director. Test participant view 904 will be presented on one or more devices for a test participant of a plurality of test participants.

Lock button 906 and lock button 908 are synchronized. In this illustrative example, the user/person that has the ability to unlock the sequence is the test director (TD). In some illustrative examples, the user that locked the sequence is the only user who can unlock the sequence. In this illustrative example, the test director has locked the sequence and has an option of unlocking the sequence. In other illustrative examples, all users with a set authorization can unlock a sequence. In some illustrative examples, lock button 906 and lock button 908 may not be present. In some illustrative examples, users with desired permissions will be allowed to edit the sequence or make changes. In some illustrative examples, the lock buttons will be replaced with at least one of internal roles or permissions.

Freeze following 907 is unique to the test director. When freeze following 907 is activated, the test director can navigate in test director view 902 without updating a display of test participant view 904. Freeze following 907 can be utilized by the test director to review notes or other information for directing testing without updating the test participant displays in real-time.

Freeze following 907 allows for the test director to move around the sequence for planning. Freeze following 907 reduces confusing jumps while the test director looks to what condition is next. Freeze following 907 can be used for re-ordering conditions.

Test participant control 909 controls the updating of test participant view 904. Test participant control 909 allows for the test participant to change between navigating through conditions independently or automatically following the test director. As currently depicted, test participant view 904 is presenting the current condition the test director is on. As currently depicted, test participant view 904 follows test director view 902 automatically and moves to the next condition as test director view 902 moves to the next condition. As currently depicted, test participant view 904 moves the sequence panel of test participant view with test director view 902.

As a result of the selections in test participant control 909, navigation panel 910 of test director view 902 and navigation panel 912 of test participant view 904 are synchronized. As a result of the selections in test participant control 909, initial setup 914 of test director view 902 and initial setup 916 of test participant view 904 are synchronized.

General notes are synchronized across test director view 902 and test participant view 904 except for personal notes. For example, redlines 918 and redlines 920 are synchronized. Updates such as redlines 918 in test director view 902 are received, integrated, and a plurality of test participant views are updated.

Test director notes are synchronized across test director view 902 and test participant view 904. For example, test director notes 922 and test director notes 924 are synchronized.

In contrast, personal note 926 is not populated across all views. Personal note 926 is not present in test director view 902. Likewise, personal note 928 is not present in test participant view 904.

Test condition table 930 and test condition table 932 are synchronized. The test director can modify the conditions in test condition table 930 of test director view 902. As the test director modifies the conditions in test condition table 930, test condition table 932 will be updated in real-time.

In this illustrative example, a real-time display comprises the test director display comprising a navigation panel, a sequence panel, and a data panel configured to display the data from dissimilar systems related to conditions for the testing of the aircraft. The test participant display is configured to automatically update current data related to the conditions with live updates. The test participant display comprises an option to automatically present a view of the test director display in a sequence panel of the test participant display. The test participant display also comprises an option to independently navigate panels in test participant view 904.

The sequence coordination system is configured to automatically update the current status of the conditions in the test participant display by at least one of updating indicators of conditions in a navigation panel of the test participant display or displaying a current condition in a sequence panel of the test participant display. In this illustrative example, icons and colors are used in navigation panel 912 and test condition table 932 of the sequence panel as indicators for the status of the conditions. Additionally, the conditions presented in the sequence panel of test participant view 904 are the current conditions.

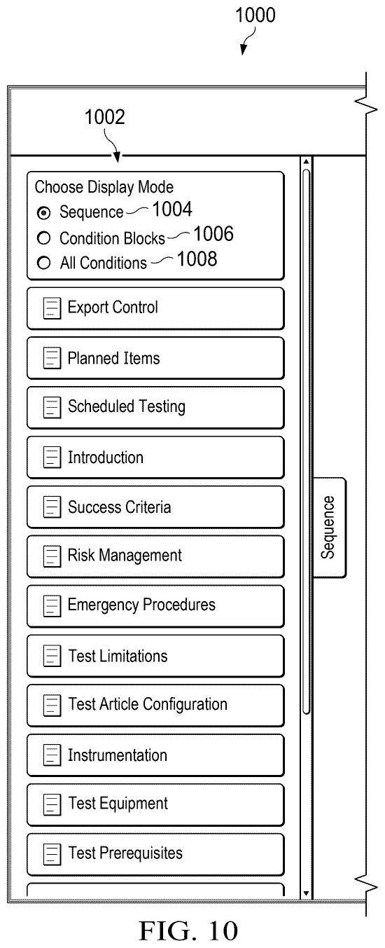

Turning now to FIG. 10, an illustration of a navigation panel is depicted in accordance with an illustrative embodiment. Navigation panel 1002 can be an implementation of one of navigation panel 230 or navigation panel 246 of FIG. 2. Navigation panel 1002 can be displayed on any desired device of onboard users 502, onboard users 504, device 514, device 516, flight crew devices 522, or devices of additional users 524 of FIG. 5. Navigation panel 1002 can be displayed on any desired device of onboard users 602, onboard users 604, device 614, device 616, or flight crew devices 622 of FIG. 6. Navigation panel 1002 can be displayed on any desired device of onboard users 702, onboard users 704, device 714, device 716, or flight crew devices 720 of FIG. 7.

View 1000 is a view of a portion of one of a test director display or a test participant display. View 1000 of navigation panel 1002 is of a portion of a graphical user interface for a sequence coordination system. Navigation panel 1002 displays the content of the sequence. Navigation panel 1002 can display at least one of test information, condition blocks, or conditions. Navigation panel 1002 can be displayed in one of three modes: sequence 1004, condition blocks 1006, or all conditions 1008. Sequence 1004 presents higher level information and can be used for informational meetings.

In this illustrative example, sequence 1004 is selected. The test information sections shown in sequence 1004 include Export Control, Planned Items, Scheduled Testing, Introduction, Success Criteria, Risk Management, Emergency Procedures, Test Limitations, Test Article Configuration, Instrumentation, Test Equipment, and Test Prerequisites.

Selecting a test information section in navigation panel 1002 will present information regarding the test information section in a sequence panel. The information presented in the sequence panel will change when a different test information section is selected.

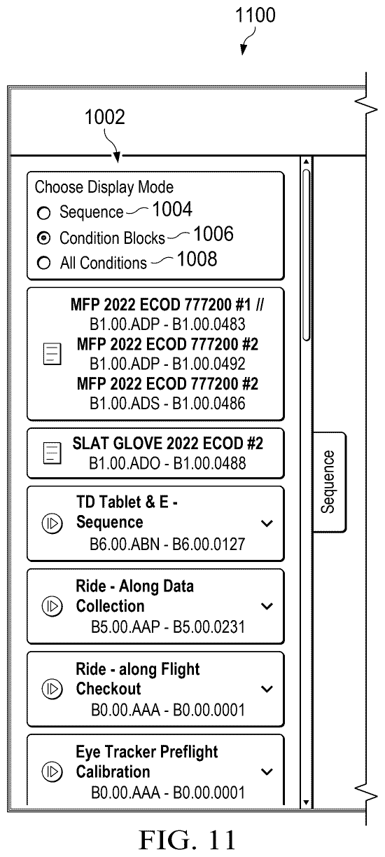

Turning now to FIG. 11, an illustration of a navigation panel is depicted in accordance with an illustrative embodiment. View 1100 is a view of navigation panel 1002 with condition blocks 1006 selected. By selecting condition blocks 1006, each condition block is shown. Each condition block comprises one or more conditions. Selecting a condition block in navigation panel 1002 will present information for the respective condition block in a sequence panel.

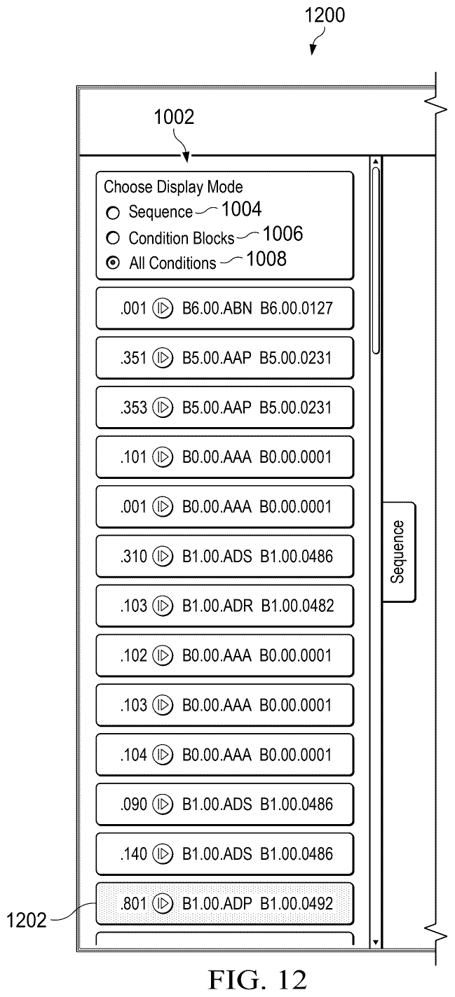

Turning now to FIG. 12, an illustration of a navigation panel is depicted in accordance with an illustrative embodiment. View 1200 is a view of navigation panel 1002 with all conditions 1008 selected. By selecting all conditions 1008, each condition is shown individually. Selecting a condition in navigation panel 1002 will present information for the respective condition in a sequence panel.

In some illustrative examples, selecting a condition will highlight all conditions within the same block within navigation panel 1002. In this illustrative example, condition 1202 is highlighted using color. More specifically, a background color for condition 1202 is different from other background colors for conditions in navigation panel 1002. In other illustrative examples, conditions can be highlighted by changing the text, placing a large box around the respective condition or any other desirable visible indication. In some illustrative example, changing the text can include changing a font, underlining text, bolding text, changing a size of the text, or any other desirable method of changing the text.

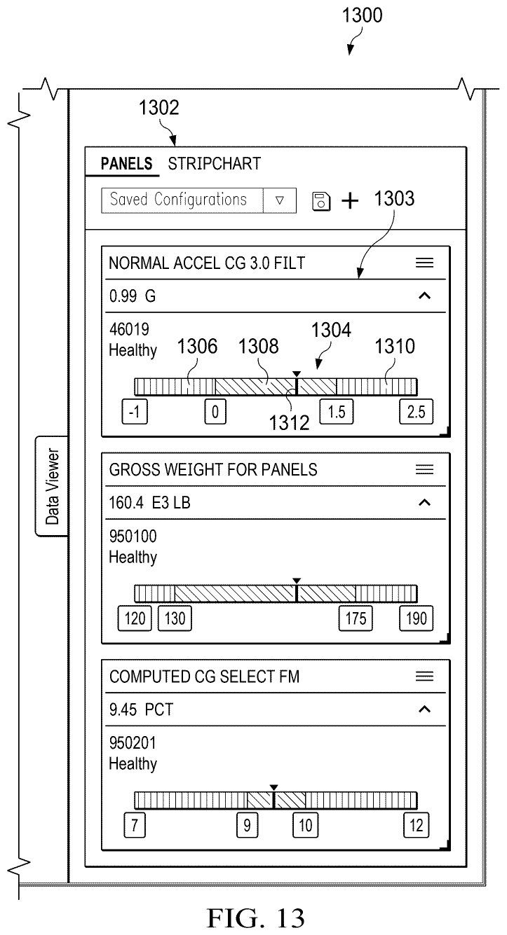

Turning now to FIG. 13, an illustration of a data panel is depicted in accordance with an illustrative embodiment. Data panel 1302 provides readouts of data that are not conventionally presented to either the flight crew and/or test directors. Conventionally, only those sitting at an operator console, or devices with appropriate core clients installed can view live data. Otherwise, some airplanes may have extremely simple “panels” with segmented displays installed that show data from one measurement at a time and have a pre-configured list of measurements that cannot be changed onboard. The panels cannot move. Conventionally, for aircraft that do not have panels, there is no live data availability (other than LADS) on the flight deck. LADS is also pre-configured and is not customized per user. Data panel 1302 brings live data to those users who don't have access to these panels, or don't have the core clients installed. Unlike conventional systems, data panel 1302 is not operating system dependent.

Data panel 1302 provides readouts of data in real-time. Data panel 1302 provides readouts of data from dissimilar systems that are integrated by the testing coordination system. The testing coordination system provides real-time reception and integration in a real-time changeable display. Data panel 1302 also allows customization on the fly per user.

A test director can utilize data panel 1302 to assist with managing the testing to ensure the aircraft is within the test limitations. Data panel 1302 provides measurement value with a 0.5 sec refresh rate.

In this illustrative example, data panel 1302 comprises graphic bars 1303. Graphic bars 1303 depict custom and flight limits. Graphics bar 1304 provides information to the test director to determine whether variables are maintained within limits during testing. In some illustrative examples, graphics bar 1304 can provide information to a test director to inform whether pre-test values are present prior to beginning a condition.

In this illustrative example, graphics bar 1304 utilizes colors to depict limits. For example, within limits values 1308 are indicated in green. In this illustrative example, below limits values 1306 and above limits values 1310 are depicted in red. Measurement value 1312 is depicted as a black line and arrow. In this illustrative example, measurement value 1312 is present in within limits values 1308.

Graphics bar 1304 can be decluttered out of view. In some illustrative examples, measurement values and arrow changes to red when limits are exceeded.

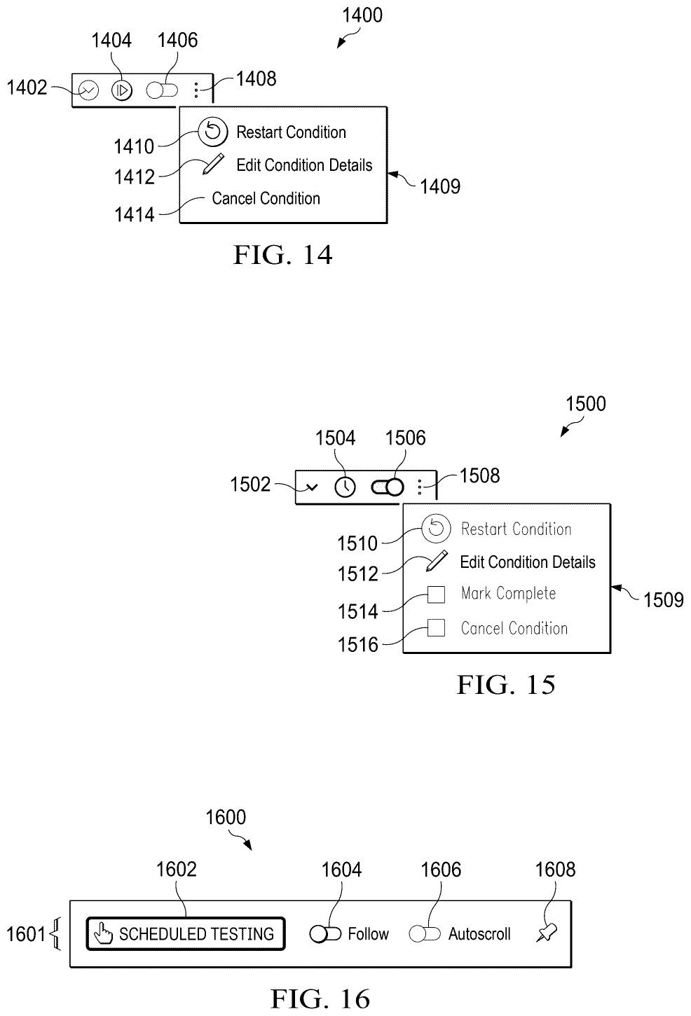

Turning now to FIG. 14, an illustration of sequence condition controls is depicted in accordance with an illustrative embodiment. Sequence condition controls 1400 are commands to starting, pausing, recurring, and cancelling conditions. Condition declutter 1402 can be used to show more or less information about the selected condition. Condition status 1404 will change when controlled. In this illustrative example, condition status 1404 indicates that the condition has not been started. Conditions are marked complete when the condition has occurred.

Condition control 1406 starts or pauses the selected condition. Icon 1408 displays or closes condition menu 1409. Condition menu 1409 includes restart condition 1410, edit condition details 1412, and cancel condition 1414.

Turning now to FIG. 15, an illustration of sequence condition controls is depicted in accordance with an illustrative embodiment. Sequence condition controls 1500 are commands to starting, pausing, recurring, and cancelling conditions. Condition declutter 1502 can be used to show more or less information about the selected condition. Condition status 1504 will change when controlled. In this illustrative example, condition status 1504 indicates that the condition has been started. Conditions are marked complete when the condition has occurred.

Condition control 1506 starts or pauses the selected condition. In this illustrative example, the condition is running (in progress) in this depiction. Icon 1508 displays or closes condition menu 1509. Condition menu 1509 includes restart condition 1510, edit condition details 1512, mark complete 1514, and cancel condition 1516. In this illustrative example, restart condition 1510, mark complete 1514, and cancel condition 1516 are not active.

Turning now to FIG. 16, an illustration of sequence following controls is depicted in accordance with an illustrative embodiment. View 1600 is of sequence following controls 1601. Sequence following controls 1601 are present in test participant views.

Clicking button 1602 currently labeled as “Scheduled Testing” jumps to the condition the test director is currently on. Button 1602 can be used to determine the current condition for testing. Button 1602 can be used to return to a current condition of a test director display after navigating through the sequence. In some illustrative examples, button 1602 can changes the text displayed based on where the test director is. In this illustrative example, button 1602 shows that the test director is currently in the scheduled testing section. If the test director was in a condition, the name of button 1602 can be changed in-real time to show that condition's name. Button 1602 is another indicator of where the test director is in the sequence at all times. Clicking button 1602 takes the user to that section. While following (follow 1604 is toggled ON), button 1602 is disabled, but can still update the text. In some illustrative examples, the icon on button 1602 can also be changed in real time.

Toggling follow 1604 controls which condition is present in a sequence panel. Toggling follow 1604 moves between following the test director or navigating independently through the sequence of conditions. Toggling follow 1604 follows the test director by automatically moving to the next condition as the test director display moves to the next condition.

Autoscroll 1606 controls a view within the sequence panel. Toggling autoscroll 1606 moves between following the test director or navigating independently within the sequence panel. Toggling autoscroll 1606 moves the sequence panel of the test participant display with the test director display.

Pin 1608 can be used to move sequence following controls 1601 in a test participant display. Pin 1608 In some illustrative examples, pin icon 1608 is by default enabled. This option pins controls 1601 to the top of the screen even if the user scrolls down. Unpinning controls 1601 using pin 1608 scrolls the bar off screen when the user scrolls down.

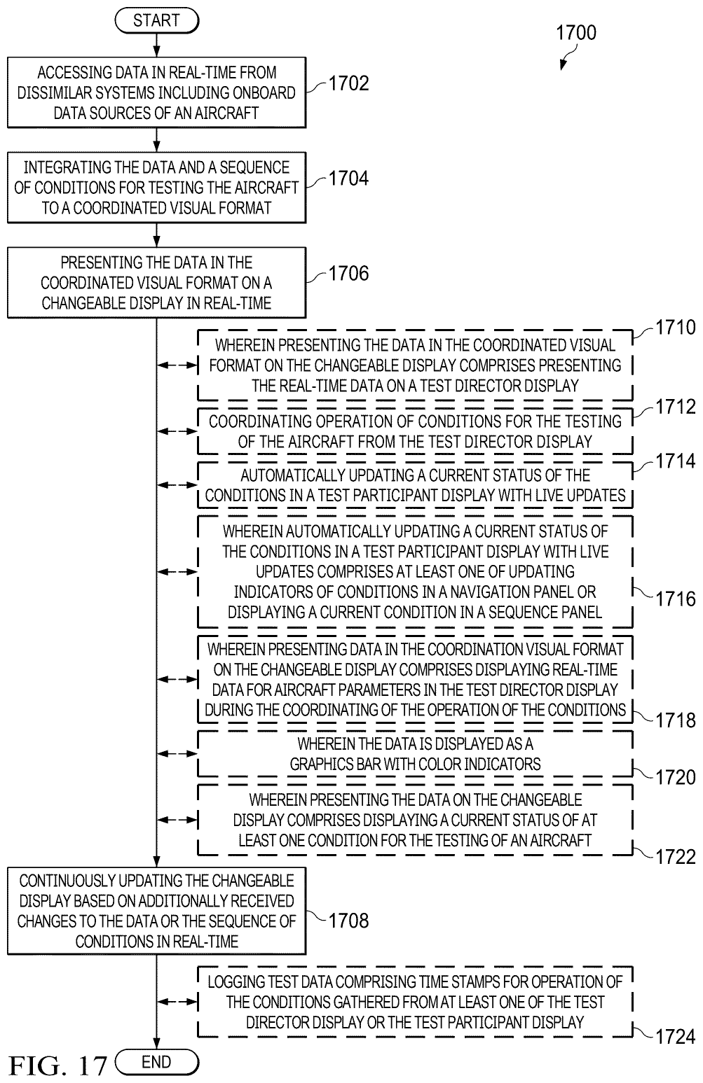

Turning now to FIG. 17, a flowchart of a method of testing of an aircraft using reduced audio communications is depicted in accordance with an illustrative embodiment. Method 1700 can be implemented to test aircraft 100 of FIG. 1. Method 1700 can be implemented in testing environment 200 using testing coordination system 209 of FIG. 2. Method 1700 can be implemented using testing coordination system 300 of FIG. 3. Method 1700 can be implemented using testing coordination system 401 of FIG. 4. Method 1700 can be implemented using testing coordination system 500 of FIG. 5. Method 1700 can be implemented using testing coordination system 600 of FIG. 6. Method 1700 can be implemented using testing coordination system 700 of FIG. 7. The changeable display continuously updated in method 1700 can include any of the displays or portions of displays in FIGS. 8-13.

Method 1700 accesses data in real-time from dissimilar systems including onboard data sources of an aircraft (operation 1702). Method 1700 integrates the data and a sequence of conditions for testing the aircraft to a coordinated visual format (operation 1704). Method 1700 presents the data in the coordinated visual format on a changeable display in real-time (operation 1706). Method 1700 continuously updates the changeable display based on additionally received changes to the data or the sequence of conditions in real-time (operation 1708). Afterwards, method 1700 terminates.

In some illustrative examples, presenting the data in the coordinated visual format on the changeable display comprises presenting the real-time data on a test director display (operation 1710).

In some illustrative examples, method 1700 coordinates operation of conditions for the testing of the aircraft from the test director display (operation 1712). In some illustrative examples, method 1700 automatically updates a current status of the conditions in a test participant display with live updates (operation 1714). Input from the test director display can be used to control the operation of the testing. In some illustrative examples, input from the test director display can be used to update at least one of icons, colors, or other indicators of a current status of a condition. In some illustrative examples, input from the test director display can be used to automatically change information presented on test participant displays.

In some illustrative examples, automatically updating a current status of the conditions in a test participant display with live updates comprises at least one of updating indicators of conditions in a navigation panel or displaying a current condition in a sequence panel (operation 1716). In some illustrative examples, presenting the data in the coordinated visual format on the changeable display comprises displaying real-time data for aircraft parameters in the test director display during the coordinating of the operation of the conditions (operation 1718). In some illustrative examples, the data is displayed as a graphics bar with color indicators (operation 1720). In some illustrative examples, presenting the data on the changeable display comprises displaying a current status of at least one condition for the testing of an aircraft (operation 1722).

In some illustrative examples, method 1700 logs test data comprising time stamps for operation of the conditions gathered from at least one of the test director display or the test participant display (operation 1724). Data generated by the displays can be saved to a data server.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1710 through operation 1724 may be optional.

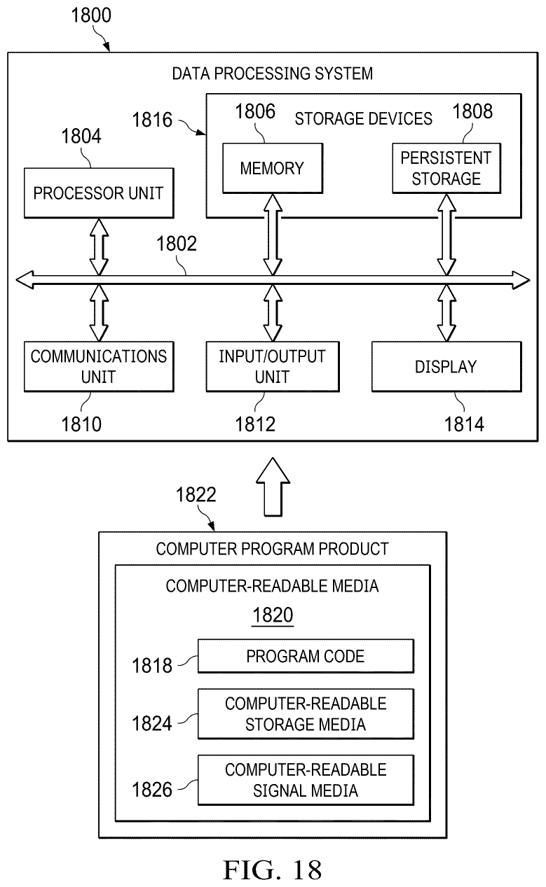

Turning now to FIG. 18, an illustration of a block diagram of a data processing system is depicted in accordance with an illustrative embodiment. Data processing system 1800 may be used to implement computer systems or servers for a sequence coordination system or devices for presenting a real-time data display. Data processing system 1800 may be used to implement any of the servers or devices in FIG. 3, FIG. 5, FIG. 6, or FIG. 7. In this illustrative example, data processing system 1800 includes communications framework 1802, which provides communications between processor unit 1804, memory 1806, persistent storage 1808, communications unit 1810, input/output (I/O) unit 1812, and display 1814. In this example, communications framework 1802 takes the form of a bus system.

Processor unit 1804 serves to execute instructions for software that may be loaded into memory 1806. Processor unit 1804 may be a number of processors, a multi-processor core, or some other type of processor, depending on the particular implementation. In an embodiment, processor unit 1804 comprises one or more conventional general-purpose central processing units (CPUs). In an alternate embodiment, processor unit 1804 comprises one or more graphical processing units (GPUs).

Memory 1806 and persistent storage 1808 are examples of storage devices 1816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1816 may also be referred to as computer-readable storage devices in these illustrative examples. Memory 1806, in these examples, may be, for example, a random access memory or any other suitable volatile or non-volatile storage device. Persistent storage 1808 may take various forms, depending on the particular implementation.

For example, persistent storage 1808 may contain one or more components or devices. For example, persistent storage 1808 may be a hard drive, a flash memory, a rewritable optical disk, a rewritable magnetic tape, or some combination of the above. The media used by persistent storage 1808 also may be removable. For example, a removable hard drive may be used for persistent storage 1808. Communications unit 1810, in these illustrative examples, provides for communications with other data processing systems or devices. In these illustrative examples, communications unit 1810 is a network interface card.

Input/output unit 1812 allows for input and output of data with other devices that may be connected to data processing system 1800. For example, input/output unit 1812 may provide a connection for user input through at least one of a keyboard, a mouse, or some other suitable input device. Further, input/output unit 1812 may send output to a printer. Display 1814 provides a mechanism to display information to a user.

Instructions for at least one of the operating system, applications, or programs may be located in storage devices 1816, which are in communication with processor unit 1804 through communications framework 1802. The processes of the different embodiments may be performed by processor unit 1804 using computer-implemented instructions, which may be located in a memory, such as memory 1806.

These instructions are referred to as program code, computer-usable program code, or computer-readable program code that may be read and executed by a processor in processor unit 1804. The program code in the different embodiments may be embodied on different physical or computer-readable storage media, such as memory 1806 or persistent storage 1808.

Program code 1818 is located in a functional form on computer-readable media 1820 that is selectively removable and may be loaded onto or transferred to data processing system 1800 for execution by processor unit 1804. Program code 1818 and computer-readable media 1820 form computer program product 1822 in these illustrative examples. In one example, computer-readable media 1820 may be computer-readable storage media 1824 or computer-readable signal media 1826.

In these illustrative examples, computer-readable storage media 1824 is a physical or tangible storage device used to store program code 1818 rather than a medium that propagates or transmits program code 1818. Computer readable storage media 1824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1818 may be transferred to data processing system 1800 using computer-readable signal media 1826. Computer-readable signal media 1826 may be, for example, a propagated data signal containing program code 1818. For example, computer-readable signal media 1826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1800 are not meant to provide architectural limitations to the manner in which different embodiments may be implemented. The different illustrative embodiments may be implemented in a data processing system including components in addition to or in place of those illustrated for data processing system 1800. Other components shown in FIG. 18 can be varied from the illustrative examples shown. The different embodiments may be implemented using any hardware device or system capable of running program code 1818.

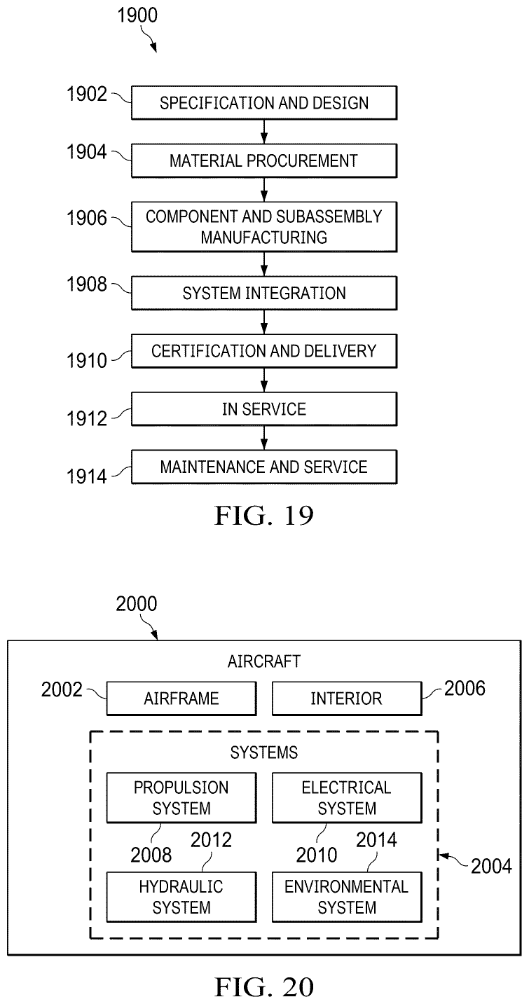

Illustrative embodiments of the present disclosure may be described in the context of aircraft manufacturing and service method 1900 as shown in FIG. 19 and aircraft 2000 as shown in FIG. 20. Turning first to FIG. 19, an illustration of an aircraft manufacturing and service method in a form of a block diagram is depicted in accordance with an illustrative embodiment. During pre-production, aircraft manufacturing and service method 1900 may include specification and design 1902 of aircraft 2000 in FIG. 20 and material procurement 1904.

During production, component and subassembly manufacturing 1906 and system integration 1908 of aircraft 2000 takes place. Thereafter, aircraft 2000 may go through certification and delivery 1910 in order to be placed in service 1912. While in service 1912 by a customer, aircraft 2000 is scheduled for routine maintenance and service 1914, which may include modification, reconfiguration, refurbishment, or other maintenance and service.

Each of the processes of aircraft manufacturing and service method 1900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 20, an illustration of an aircraft in a form of a block diagram is depicted in which an illustrative embodiment may be implemented. In this example, aircraft 2000 is produced by aircraft manufacturing and service method 1900 of FIG. 19 and may include airframe 2002 with plurality of systems 2004 and interior 2006. Examples of systems 2004 include one or more of propulsion system 2008, electrical system 2010, hydraulic system 2012, and environmental system 2014. Any number of other systems may be included.

Apparatuses and methods embodied herein may be employed during at least one of the stages of aircraft manufacturing and service method 1900. One or more illustrative embodiments may be manufactured or used during at least one of component and subassembly manufacturing 1906, system integration 1908, in service 1912, or maintenance and service 1914 of FIG. 19.

The present illustrative examples increase effectiveness, efficiency, productivity, and quality of test execution by providing interactivity, data access, crew resource management, and integration. The present illustrative examples provide improvements by enabling interactivity in the form of real-time changes, adding personal notes, and creating checkable items with an ability to collect a time stamp.

The present illustrative examples provide improvements by providing data access. The sequence coordination system provides a software data viewer with customizable limits and eliminates hardware. The sequence coordination system provides real-time integration to systems that previously only provided input to select hardware. Automated checking/unchecking of steps by using data will assist the test director with ensuring condition limits are met.

Some illustrative examples provide improvements by pairing audio communications with visual tracking to provide real-time display. In some illustrative examples, the real-time display and integration allows the test participants to know where the test director is during execution and provides real-time condition status.

The illustrative examples provide improvements by enhancing data collection and processing. The illustrative examples provide an ability to collect condition starts/stops times in real-time. The illustrative examples provide status and create a digital output.

The illustrative examples provide integration with current tools. The illustrative examples are configured to add data to flight test tools such as start/stop times on strip charts. Data integration with the sequence will assist the test director with managing the test to improve data quality, examples are data viewing and automated checks of steps using data, and will allow for any type of data integration or alignment with Model-based systems engineering (MBSE).

The illustrative examples recognize and take into account that in conventional systems, a test director would use a dedicated LADS display onboard. The illustrative examples provide for display of data in graphical representations of test data on devices such as laptops, tablets, or other desirable types of displays. The illustrative examples provide for display of data without use of LADS for the test director.

The illustrative examples are able to be used either hardwired or over Wi-Fi. The illustrative examples are able to be used with any device that has a web browser.

In the sequence coordination system, there can be user defined roles. The illustrative examples can provide the capability for user generated personal notes.

The illustrative examples provide an interactive, digital sequence that can be used to execute a test efficiently. Results showed the crew were able to follow the TD easily, allowed the pilots to access customized data, enhanced data analysis by incorporating execution data digitally with other tools and provided common updates for all crew members enhancing CRM.

The illustrative examples provide a server-based application that includes an interactive digital sequence to the test participants. The sequence coordination system uses REACT programming to digitize and enable the sequence to be displayed on any device with a web browser. As the test director makes changes to the sequence, updates are sent to all participants, which enables visual communication as the test director steps through the sequence.

The illustrative examples can provide multiple methods of communication. The illustrative examples can provide comments. The illustrative examples can provide chat rooms to allow for test participants to communicate and share images/files throughout the aircraft. In some illustrative examples, audio communication is provided through the sequence coordination system. At least one of a current condition, current condition block, or status of a current condition can be conveyed through at least one of color, icons, or real-time updated text. In some illustrative examples, pop-up boxes can be used so that the user does not need to jump screens to find information.

The illustrative examples allow changes to the sequences to be made prior to, and throughout, the test event. The sequence coordination system populates changes to a sequence throughout the plurality of test participant displays in real-time during a test.

The design of the testing coordination system allows for sequence transmissions for telemetry tests where IP protocols are used.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments.

The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A testing coordination system comprising:
a data storage server configured to receive onboard data from data sources on an aircraft in real-time; and
a sequence coordination system on at least one sequence coordination server and configured to receive the onboard data from the data storage server, convert to a visualization of the onboard data, integrate the visualization with data from dissimilar systems, and present the visualization and data from dissimilar systems in a real-time display.

2. The testing coordination system of claim 1, wherein the real-time display comprises a test director display comprising a navigation panel, a sequence panel, and a data panel configured to display the data from the dissimilar systems related to conditions for the testing of the aircraft, and further comprising:
a test participant display configured to automatically update current data related to the conditions with live updates.

3. The testing coordination system of claim 2, wherein the test participant display comprises an option to automatically present a view of the test director display in a sequence panel of the test participant display.

4. The testing coordination system of claim 2, wherein the sequence coordination system is configured to automatically update a current status of the conditions in the test participant display by at least one of updating indicators of conditions in a navigation panel of the test participant display or displaying a current condition in a sequence panel of the test participant display.

5. The testing coordination system of claim 1, wherein the sequence coordination system is a web-based application configured to present the onboard data in a real-time display on a device independent of a type of operating system.

6. The testing coordination system of claim 1, wherein the sequence coordination system is further configured to receive user input from the real-time display and associate a time stamp for the user input with the onboard data.

7. The testing coordination system of claim 1, wherein the sequence coordination system is configured to automatically integrate additional data received from at least one of the real-time display, a plurality of test participant displays, or the data storage server and update each of the real-time display and the plurality of test participant displays in real-time.

8. A testing coordination system comprising:
a sequence coordination system stored on at least one sequence coordination server and configured to provide real-time reception and integration of data to provide communication between disparate systems while presenting a real-time changeable display.

9. The testing coordination system of claim 8, wherein the sequence coordination system is a web-based application configured to present the real-time changeable display independently of a type of operating system.

10. The testing coordination system of claim 8, wherein the sequence coordination system is configured to manage a test director display and a plurality of test participant displays in real-time to integrate and display updated data from the test director display and data sources onboard an aircraft on each of the plurality of test participant displays.

11. The testing coordination system of claim 10, wherein the sequence coordination system is configured to manage a test director display and a plurality of test participant displays such that the sequence coordination system automatically presents a current view of a sequence panel of the test director display in respective sequence panels of the test participant displays in real-time.

12. The testing coordination system of claim 11, wherein the sequence coordination system is configured to associate input received from at least one of the test director display or a test participant display of the plurality of test participant displays with data from the data sources onboard the aircraft in real-time.

13. The testing coordination system of claim 11, wherein the sequence coordination system is configured to communicate a current status of testing using at least one of real-time updated icons, real-time updated colors, or real-time updated text.

14. A method of testing of an aircraft using reduced audio communications comprising:
accessing data in real-time from dissimilar systems including onboard data sources of an aircraft;
integrating the data and a sequence of conditions for testing the aircraft to a coordinated visual format;
presenting the data in the coordinated visual format on a changeable display in real-time; and
continuously updating the changeable display based on additionally received changes to the data or the sequence of conditions in real-time.

15. The method of claim 14, wherein presenting the data in the coordinated visual format on the changeable display comprises presenting the data on a test director display, the method further comprising:
coordinating operation of conditions for the testing of the aircraft from the test director display; and
automatically updating a current status of the conditions in a test participant display with live updates.

16. The method of claim 15, wherein presenting the data in the coordinated visual format on the changeable display comprises displaying real-time data for aircraft parameters in the test director display during the coordinating of the operation of the conditions.

17. The method of claim 16, wherein the real-time data is displayed as a graphics bar with color indicators.

18. The method of claim 14, wherein presenting the data on the changeable display comprises displaying a current status of at least one condition for the testing of an aircraft.

19. The method of claim 15 further comprising:
logging test data comprising time stamps for operation of the conditions gathered from at least one of the test director display or the test participant display.

20. The method of claim 15, wherein automatically updating a current status of the conditions in a test participant display with live updates comprises at least one of updating indicators of conditions in a navigation panel or displaying a current condition in a sequence panel.
